(19) United States
(12) Patent Application Publication
(10) Pub. No.: US 2011/0127443 A1
(43) Pub. Date: Jun. 2, 2011

(54) INTEGRATED BEAM MODIFYING ASSEMBLY FOR USE WITH A PROTON BEAM THERAPY MACHINE

(76) Inventors: Sean Comer, Helotes, TX (US); Johnie McConnaughhay, Greenville, SC (US)

(21) Appl. No.: 12/944,314

(22) Filed: Nov. 11, 2010

Related U.S. Application Data
(60) Provisional application No. 61/260,601, filed on Nov. 12, 2009.

(51) Int. Cl. H01J 3/14

(52) U.S. Cl. 250/396 R

(57) ABSTRACT

An integrated beam modifying assembly for use with a proton beam therapy machine. Typically the snouts of a proton beam therapy machine are adapted to receive separate apertures and range compensators. Applicants provide an integrated assembly for slotting into the snout of a proton beam therapy machine, which integrated assembly incorporates both aperture material and range compensator material for profiling, shaping, and modulating the beam.

This application claims the benefit of and incorporates herein by reference US Provisional Patent Application Ser. No. 61/260,601, filed Nov. 12, 2009.

### FIELD OF THE INVENTION

Ion (charged particles) beam modifying devices for use with beam accelerator machines, more specifically, proton beam modulation and shaping devices.

### BACKGROUND OF THE INVENTION

The proton beam therapy (PBT) is used for the treatment of certain types of cancers. Proton beam therapy is a fairly recent type of cancer treatment. It is a localized form of radiation therapy in which a proton beam is directed solely at a tumor lying deep within the body in order to destroy the tumor. Proton beam therapy has minimal side effects as the proton beam has little effect on the surrounding healthy tissue and typically only cancerous cells are treated.

Proton beam therapy (PBT) utilizes a medical device designed to produce and deliver a proton beam for the treatment of patients that may benefit from treatment by radiation. It is designed to deliver a proton beam with a prescribed dose and dose distribution to the prescribed patient treatment site.

One area where proton therapy has had considerable success is in treating choroidal malignant melanomas, a type of eye cancer for which the only known treatment was removal of the eye. Today proton therapy is one of the techniques that is capable of treating this tumor without mutilation. Proton beam therapy is typically used on cancers that have not spread. Proton beam therapy has also had remarkable success in the treatment of many other types of cancer, including brain and spinal tumors, as well as prostate cancer.

The PBT equipment is comprised of two main components. One is a beam delivery system whose primary responsibility is to ensure that the prescription parameters are properly delivered. The other is the equipment necessary to generate the proton beam and direct it to the beam delivery system.

A particle accelerator, either a synchrotron or a cyclotron, accelerates protons to variable energies into the beam transport line. A synchrotron contains a ring of magnets that constrains the protons so that they travel in a set path inside the high vacuum chamber. During each revolution of travel through the chamber, the protons gain an increment of energy from the radio frequency power. After many cycles, the protons reach the energy required by the specific treatment planning system and are extracted from the ring into the beam transport line, which directs the proton beam to the patient in a treatment room.

PBT uses protons rather than photons (for example, x-rays). The positive charge and large mass of the proton makes it easier to control its placement within the patient. Energized protons slow down as they pass through tissue displaying minimal lateral scattering and depositing most of their energy at the end of their path. Through sophisticated algorithms, the penetration depth and shape of the protons are three dimensionally controlled to fit precisely with a tumor target.

Through their relatively large mass, a proton cannot scatter much in the tissue; the beam does not broaden much and stays focused on the tumor shape without much damage to surrounding tissue. All protons of a given energy have a certain range; no protons penetrate beyond that distance. Furthermore, the dose delivered to the tissue is at a maximum just over the last few millimeters of the particle's range; this maximum is called the Bragg peak. This depth depends on the energy to which the particles were accelerated by the proton accelerator, which can be adjusted to the maximum rating of the accelerator (typically 70-250 MeV). It is therefore possible to focus the cell damage due to the proton beam at the very depth in the tissues where the tumor is situated, tissue situated before the Bragg peak receiving only a reduced dose and tissue situated after the peak receive none.

Apertures and compensators are beam modifying devices that control the shape and penetration of proton beams during patient specific custom design cancer treatment regimens. These devices are typically connected to the snout, a massive piece of equipment, designed for receiving high energy proton beams. Treatment physicians determine the exact size, shape, and location of a patient's tumor. A dosemitrist performs the dose planning. A medical physicist prepares a prescription that includes the design of the aperture and range compensator.

The aperture is typically brass and controls the profile of the beam. They can be up to several inches thick and may measure from small to large in diameter for receipt into the snout of, for example, an IBA or a Still River machine. The aperture has a unique aperture opening shape, but masks the beams so that they are conformed to the desired treatment area and leave surrounding healthy tissue unaffected.

Present PBT machines use two blocks, each which use a single-homogenous material, typically brass (aperture material) and typically acrylic (range compensator material), that has been shaped three-dimensionally and placed in sliding engagement with the slots of the snout. Careful registration or indexing of the radiation modulator (range compensator) and aperture material in the snout provides that the patient has the proper exposure in the tumor area of the PB, such that the proton's energy is released within the tumor area.

Prior art proton beam modification comprises the use, with, for example, the Hitachi M.D. Anderson, IBA (Belgium), and Still River (Littleton, Mass.) PBT systems, of separate aperture portions. These separate portions and separate range compensator portions placed adjacent one another, slide into the seat or slots into PBT head.

The PBT machines do not fully expose the aperture and range compensator to the proton beam, instead there is typically about an approximately 2 cm border region in some embodiments around the perimeter of the seat or slot arrangement, which is substantially free of the proton beam. This is the area outside or beyond the interior diameter or id or the lip as seen in FIGS. 1A and 1B. That is to say, the machine uses an excess of the heavy, dense, and expensive aperture material, typically brass, which excess represents a perimeter or outer portion thereof which is not even exposed to the beam.

### SUMMARY OF THE INVENTION

A device or devices for use with a PBT machine, the PBT machine typically having a gantry and a snout and a proton beam emitter for emitting a proton beam, the gantry for engaging the snout, the snout having one or more slots, the one or more slots having slot walls and having indexing means thereon, the slots having a perimeter, a system for modifying the proton beam, the system typically comprises at least an aperture material for engaging the proton beam; and a range compensator material for engaging the proton beam; and typically a frame. The term “snout” may also be used to describe structure to hold aperture and/or range compensator with respect to a proton beam.

The frame may be considered a member with an outer perimeter shaped for receipt into a slot or other receiving members of a PBT machine, which is separate from the member constituting the proton beam blocking function.

The aperture material or the range compensator is adapted to removably engage the frame, the frame being dimensioned to cooperatively engage the slot walls of a first slot of the one or more slots, so as to index the range compensator or aperture material to the snout. The frame typically comprises a material of a different composition than the material to which it is engaged.

The frame typically engages the aperture material or range compensator material and the frame may typically be rectangular or round (or other suitable shape), having an outer surface for snugly engaging the walls of the first slot. The outer surface is indexed, and the frame includes an inner surface. The aperture material is generally rectangular or round and in some embodiments, for example, the Hitachi PBT machine, has a rectangular outer surface dimensioned to engage the inner surface of the frame.

The system may include fasteners and the frame and aperture material or range compensator material may include holes dimensioned to receive the fasteners therein.

The system may include means cooperating with the frame and the aperture or range compensator material so as to properly align the aperture material with the frame.

The frame may include an integral cavity portion, the cavity portion including a floor, interior walls defining an aperture opening and interior side walls, and the aperture material may engage the floor, and interior walls of the cavity.

The aperture material used may be a solid at room temperature.

The aperture material may be a non-solid at room temperature, and a cover for engaging the frame so as to substantially enclose the non-solid aperture material in the cavity may be used.

The aperture material may be one or more of: ecomass, cerrobend, tungsten or other materials suitable for blocking, absorbing or stopping proton beams.

The frame may be round and have an outer and an inner surface. The outer surface may be dimensioned to snugly engage the slot walls of a PBT machine. The frame may engage the aperture material and the aperture material may have a generally rectangular shape.

The compensator material may be any solid or non-solid with a density and other physical properties for modulating a proton beam.

In a further embodiment, an integrated aperture/compensator assembly for a PBT machine, the PBT machine typically having a gantry and a snout and a proton beam emitter for emitting a proton beam. The snout attaches to the gantry, The snout has one or more slots, the one or more slots have slot walls and indexing means. The slots have a perimeter. A single piece adapted to include both an aperture material and a range compensator material portion is disclosed, typically two or more materials of different compositions. The single piece includes exterior walls adapted to engage the slot walls, or exterior walls adapted to engage a frame, which, in turn, engages a PBT machine.

### BRIEF DESCRIPTION OF THE DRAWINGS

FIG. 1A is a front side perspective view of a large snout of an existing prior art IBA systems PBT machine as seen by a patient, below, looking up, with the doors closed, but without the aperture and range compensator.

FIG. 1B is a side elevational view of the snout of FIG. 1A with the doors open, so as capable of receiving the beam modifying devices in the slots therein.

FIG. 1C is a prior art cylindrical aperture device for use with an IBA or Still River system (that is to say, round in shape, not rectangular).

FIG. 1D is a prior art range compensator material for use with an IBA systems PBT machine.

FIG. 1E is a detail side view of the lower end of the snout with the doors open with the beam modifying devices therein (3 apertures), showing the relationship to one another and to the patient.

FIG. 1F is a detail view of a portion of 1 E showing the slotting of the lowermost two apertures adjacent the range compensator.

FIGS. 1G, 1H, and 1I are illustrations of beam modifying devices for use with a Hitachi machine showing the general construction and proximity of the aperture and range compensator to one another. FIGS. 1G, 1H, and 1I illustrate various views of the prior art proton beam modifying devices for the Hitachi, illustrating the manner in which the prior art uses two pieces, an aperture portion, typically brass (having a profiling or shielding function), and a range compensator portion, typically acrylic (having a beam modulating function). The two pieces are placed in close proximity to one another with a perimeter portion of the aperture and a shoulder portion of the range compensator together defining a combined thickness or shoulder capable of engaging a slot portion of the snout of a PBT machine, such as that made by, for example, Hitachi.

FIGS. 2, 2A, 2B, 2C, 2D, 2E, 2F, and 2G illustrate a novel aperture assembly for use with a separate range compensator wherein a separate frame and separate solid aperture material are engaged to one another to form an aperture assembly.

FIGS. 2H, 2I, 2J, and 2K illustrate a novel range compensator assembly for use with a separate prior art aperture material or with Applicants' novel aperture assemblies set forth herein.

FIGS. 3, 3A, 3B, and 3C all illustrate another novel aperture assembly for use with PBT machine range compensators, which aperture assembly comprises a frame integral with a shell with a cavity, the cavity capable of receiving a powder or other typically non-solid aperture material.

FIGS. 4, 4A, and 4B all illustrate another novel aperture assembly for use with range compensators, wherein a shell is utilized with a cavity capable of receiving high density typically non-solid material, and wherein the shell is adapted to engage a separate frame.

FIG. 5A is another embodiment of an aperture assembly featuring a frame defining a cylinder in which a solid aperture material may be removably attached.

FIGS. 5B and 5C illustrate perspective and elevational side views of a frame defining a cylinder in which a cavity removably engages.

FIGS. 6, 6A, and 6B all illustrate an integrated PBT assembly 200 that performs both the shielding (aperture material) and range compensation functions in a single unit, which may have a cavity for receipt of a material capable of shielding PB radiation.

FIGS. 7 and 7A illustrate an integrated PBT assembly with a cavity below or downstream of the range compensator material and adapted to receive a high density aperture material and wherein the walls of the range compensator are adapted to engage a standard snout of a PBT machine.

FIGS. 8, 8A, 8B, 8C, 8D, and 8E illustrate the integrated embodiments set forth above, except the outer walls of the range compensator material are adapted to engage an aperture frame, which aperture frame is adapted to engage the receiving slots of a standard head of a PBT machine.

### DETAILED DESCRIPTION OF THE PREFERRED EMBODIMENT

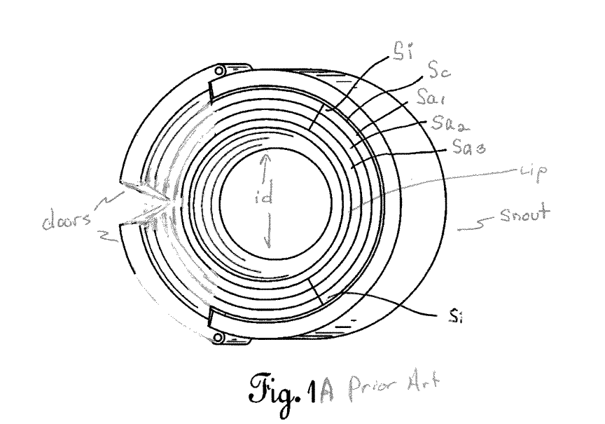

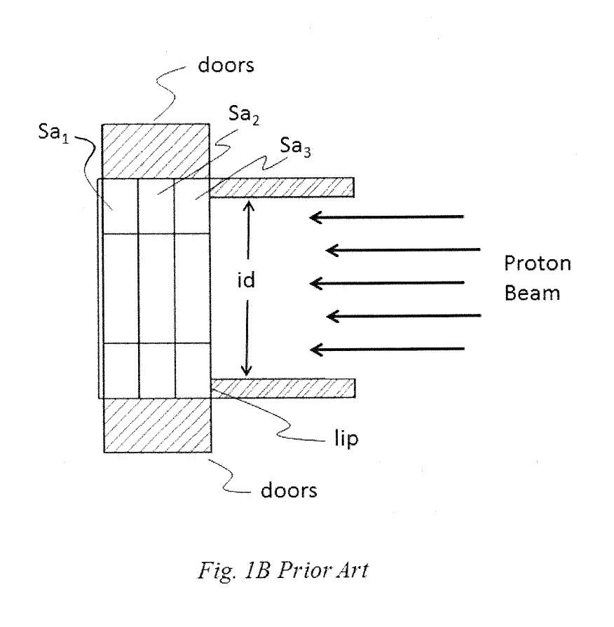

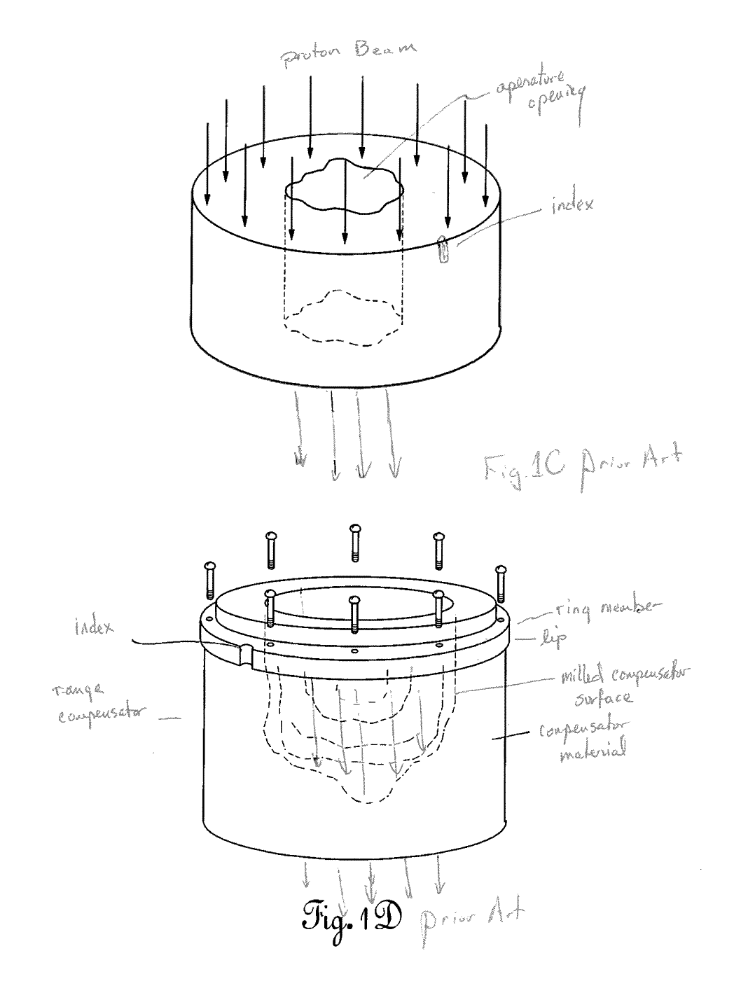

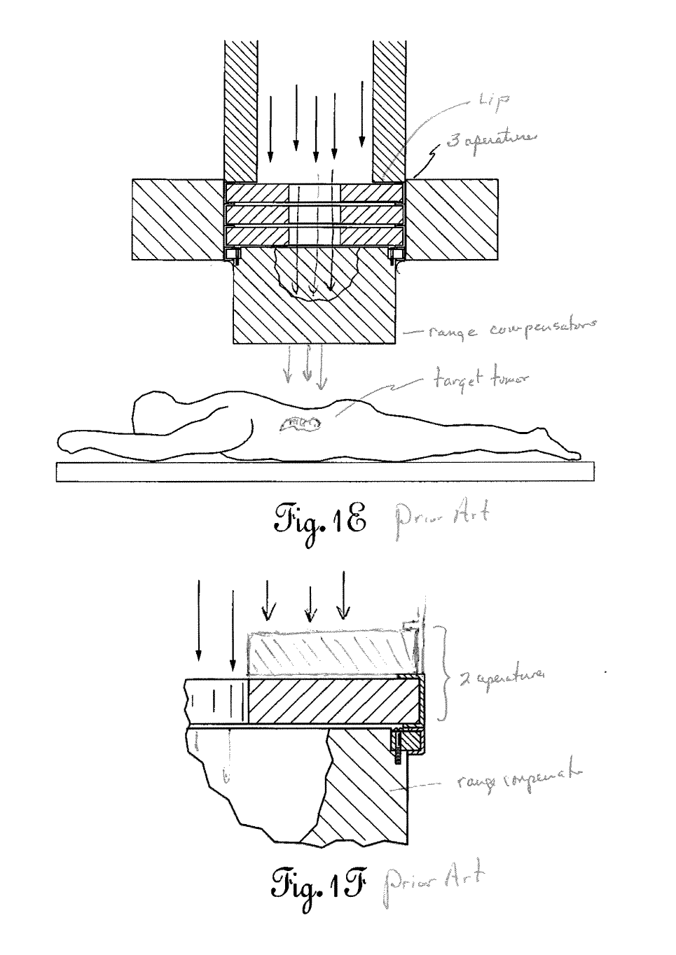

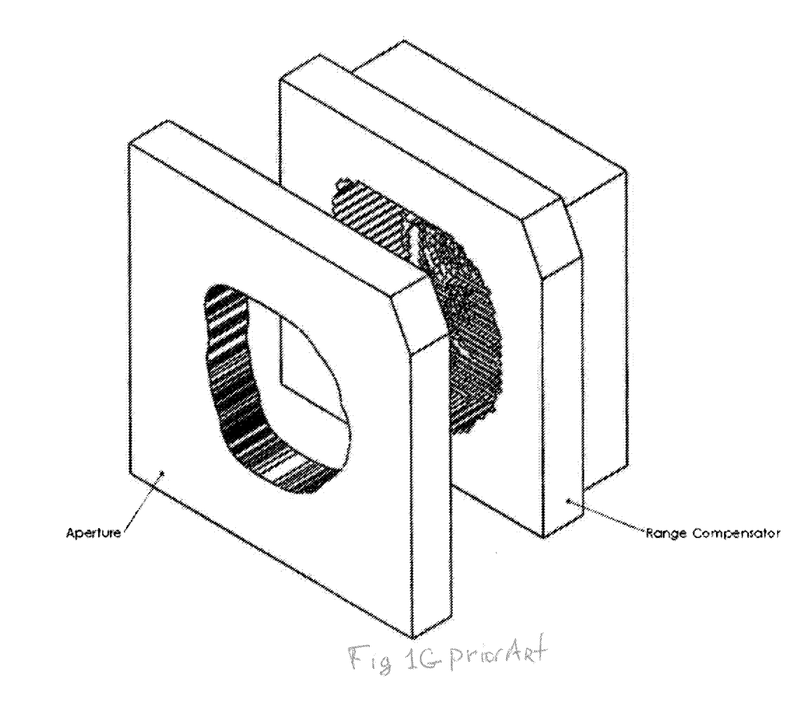

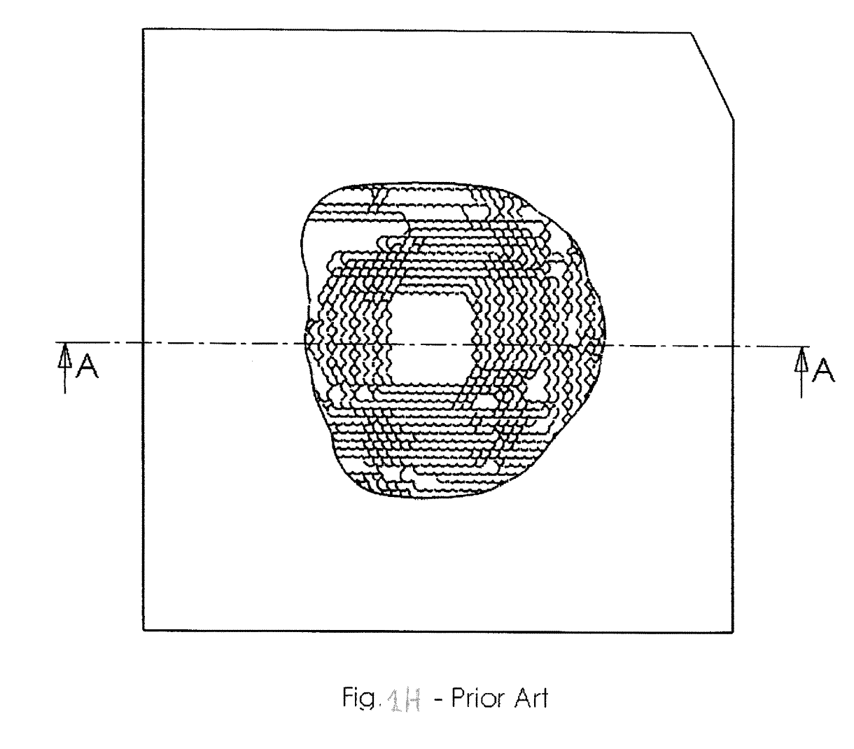

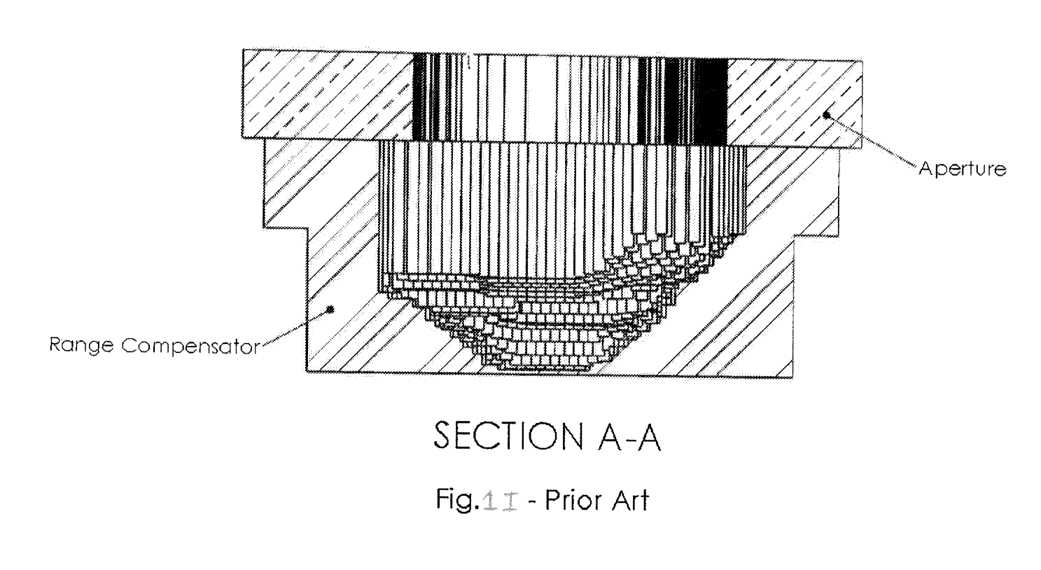

Applicants will use the Series 1 figures to explain, in some detail, existing PBT machine snouts and existing beam modifying devices (apertures and range compensators). Currently there are only a dozen or so PBT machines in the US and they are very expensive. IBA systems provide a PBT machine with a snout similar to that illustrated in FIG. 1A (round or cylindrical in shape). The snout receives high energy proton beams and is designed to hold the patient specific beam modifying devices properly oriented therein. FIG. 1A shows the view as may be seen by a patient laying on a table, with beams coming through the snout, and out of the page to expose a specifically defined area of the patient's anatomy with high energy protons (FIGS. 1A and 1B without the beam modifying devices installed). It is seen that the snout may have a pair of doors pivotally attached thereto for opening. The doors open and expose a series of slots. The number of slots depends on the size of the machine. The slots are to receive the patient specific aperture and range compensator. For example, IBA systems have snouts of small, medium, and large diameter. The small diameter snout has a single slot for the aperture material and a single slot for the compensator material, situated downstream from the aperture material. The medium size IBA system snout has a pair of slots for the aperture material to hold the aperture materials one adjacent the other and just upstream of the single slot for the compensator. In the large diameter snout (as illustrated), there exists three slots, here designated: SA1/SA2/SA3 for the three aperture materials to be received therein, one adjacent the other. These will be all upstream of the single compensator slot SC.

The reason for the three sizes is the weight of aperture materials, which typically are made of a very dense material, such as brass. Where the small snout uses small diameter, the medium has a larger interior diameter and therefore the aperture devices are heavier, necessitating two individual aperture devices rather than one heavy one. Likewise, the large IBA system snout has the largest interior diameter and, if there was only a single slot in the snout for the aperture material, it would be too heavy for a person to place in the slot; therefore, three are used for ease of handling, and placed next to one another, as in FIG. 1E. Note that the overall thickness of the aperture material is, in total, about the same. That is, the total thickness is sufficient to substantially block the proton beam except in the aperture opening.

What is to be appreciated is the weight of the aperture material. Likewise, it is appreciated how the aperture materials may be indexed with a slot index member, typically transverse to the slot either all the way across or notched part way across. This allows indexing of the aperture material to the slot, because the aperture opening is patient specific and must be oriented properly in the slot to deliver a dose in the proper shape to the correct area on the patient.

FIG. 1B illustrates a cross-sectional view showing the large diameter of the IBA systems three slot snout.

Turning now to FIGS. 1C and 1D, an aperture and a range compensator in round form for use with the IBA machine are illustrated. FIG. 1C is an aperture as seen to be made of a dense material, such as brass, and having an outside diameter and an indexing notch or slot on the cylindrical surface. An aperture opening is seen, which will allow the high energy protons to pass through, with the rest of the beam not passing through the aperture opening. It is also seen that the cylindrical aperture opening will fit snugly into the slot and is dimensioned for snug receipt into the slot when indexed to the snout.

In FIG. 1D, a range compensator of the prior art designed for use with the IBA systems machine and with an aperture material similar to that set forth in FIG. 1C is illustrated. It may be made from acrylic (or other suitable material) and is typically milled out to a patient specific milled compensator surface. It typically includes a ring member engaged to the acrylic block, which ring member defines a protruding lip that is enageable with the compensator slot of the snout. The solid end of the range compensator is typically downstream of the proton beam and the range compensator itself is typically slotted downstream of the aperture or apertures used with the machine.

Turning to FIGS. 1E and 1F, further details are provided to show the nature of engagement of the beam modifying devices with the snout and with one another. In FIG. 1E, it is seen that the three aperture devices are slotted with one adjacent the other and properly uniquely indexed, and then downstream of the three aperture devices is the range compensator, with the lip of the ring slotted therein. FIG. 1F provides a detail view of FIG. 1E, showing the range compensator material slotted with the ring thereon. It may be appreciated with reference to FIG. 1E that part of the prior art heavy dense material from which the aperture is made is not exposed to the beam and that would be that portion outside the interior diameter of the snout. That is the portion outside the inner diameter id of the snout.

Turning to FIGS. 1G, 1H, and 1I, there is illustrated aperture and range compensators for use with a Hitachi PBT machine, such as the PBT machine, at University of Texas MD Anderson Cancer Center, Houston, Texas. This machine has a rectangular slot with a corner of the rectangle indexed for proper placement of both the at least one aperture material and range compensator thereinto. The two beam modifying devices are separate, but are placed close together or touching as seen in FIG. 1I, and then slotted into the Hitachi machines close to one another for providing the shaping and modulation of the proton beam. As in the IBA machines, the Hitachi machine has the one or more aperture upstream and the range compensator downstream.

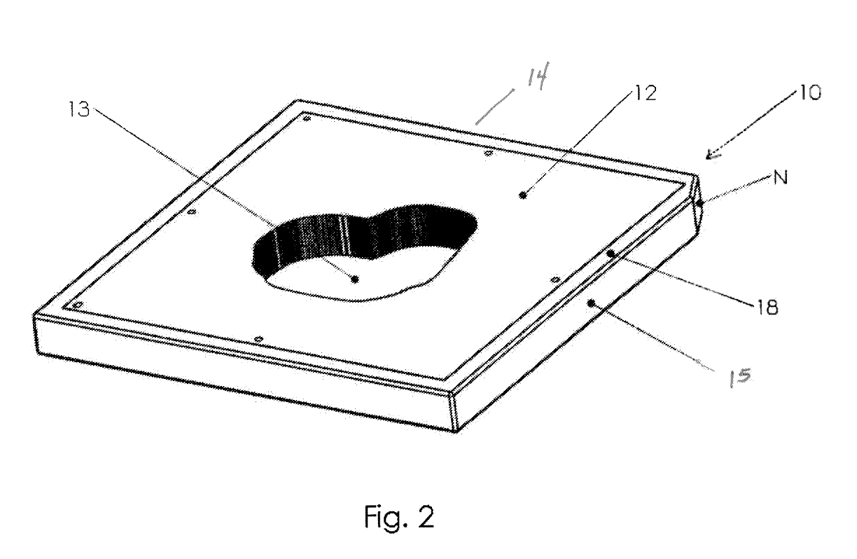

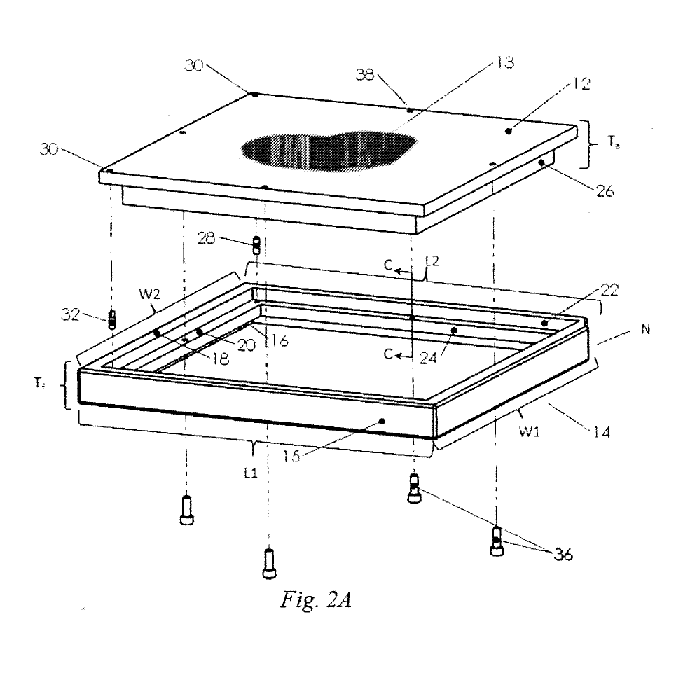

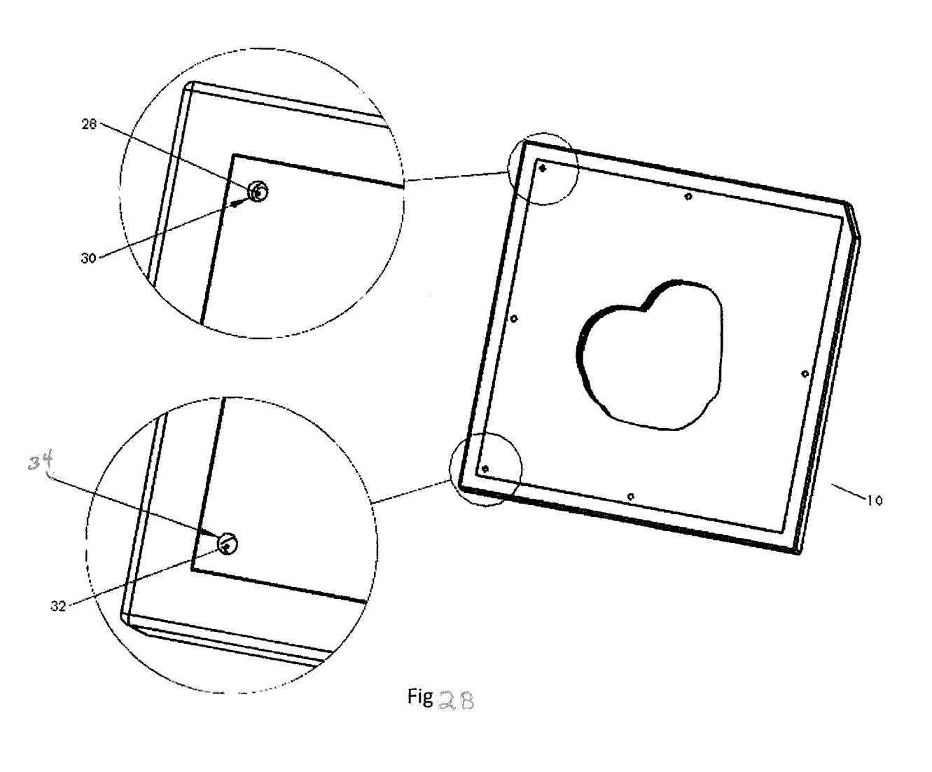

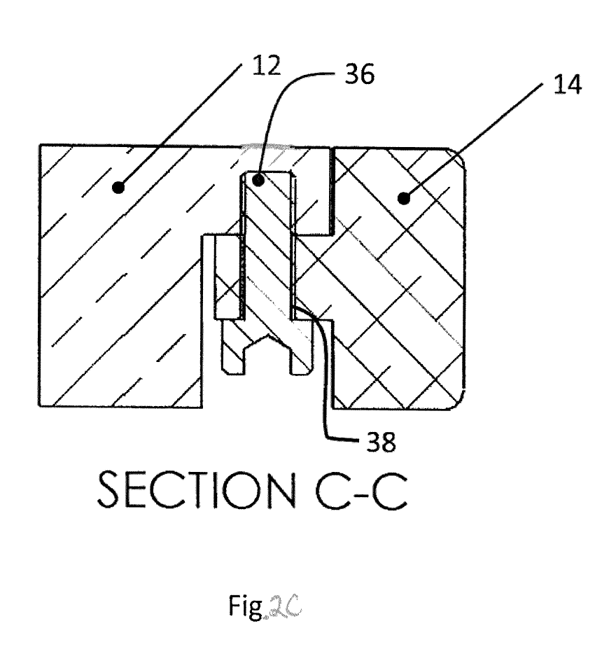

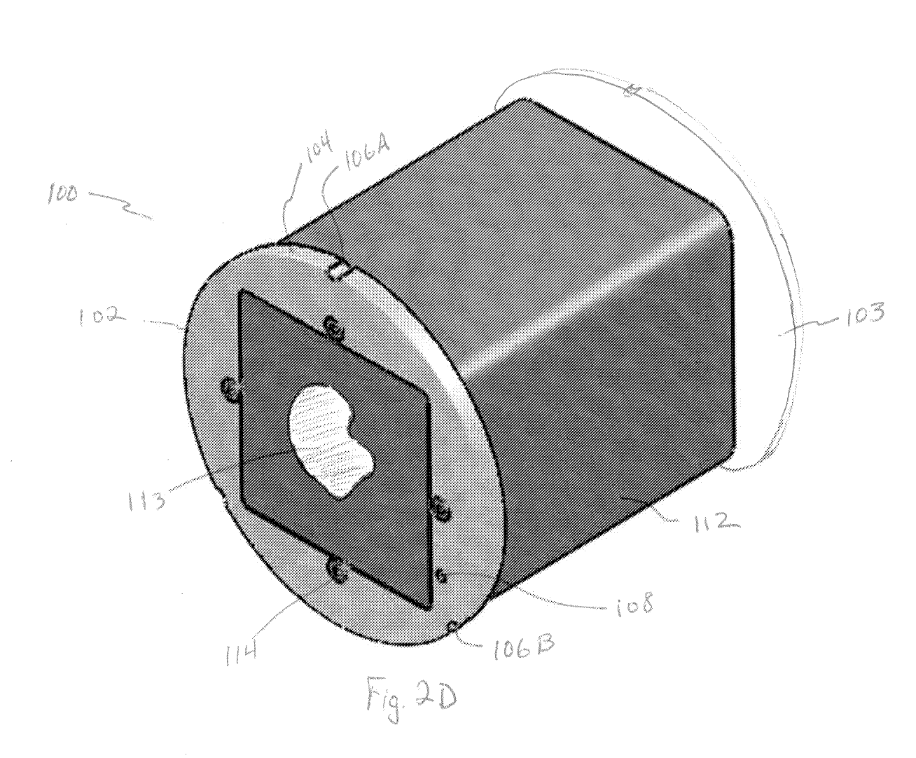

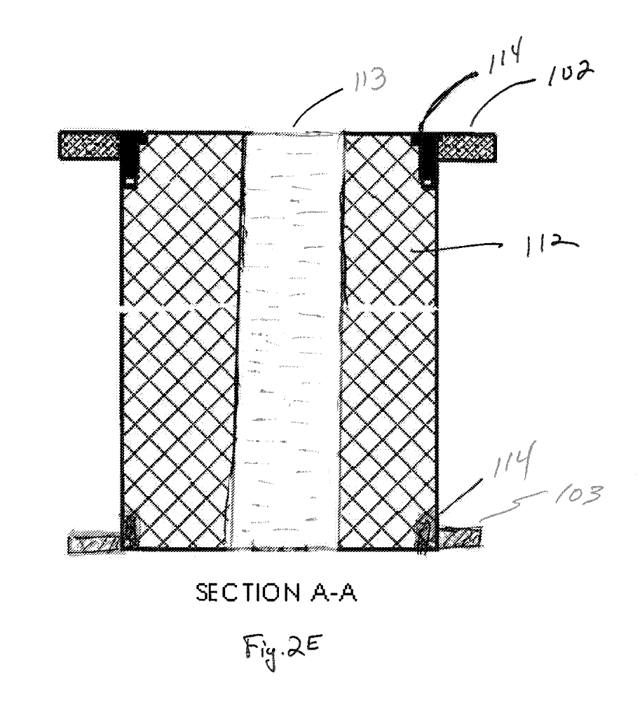

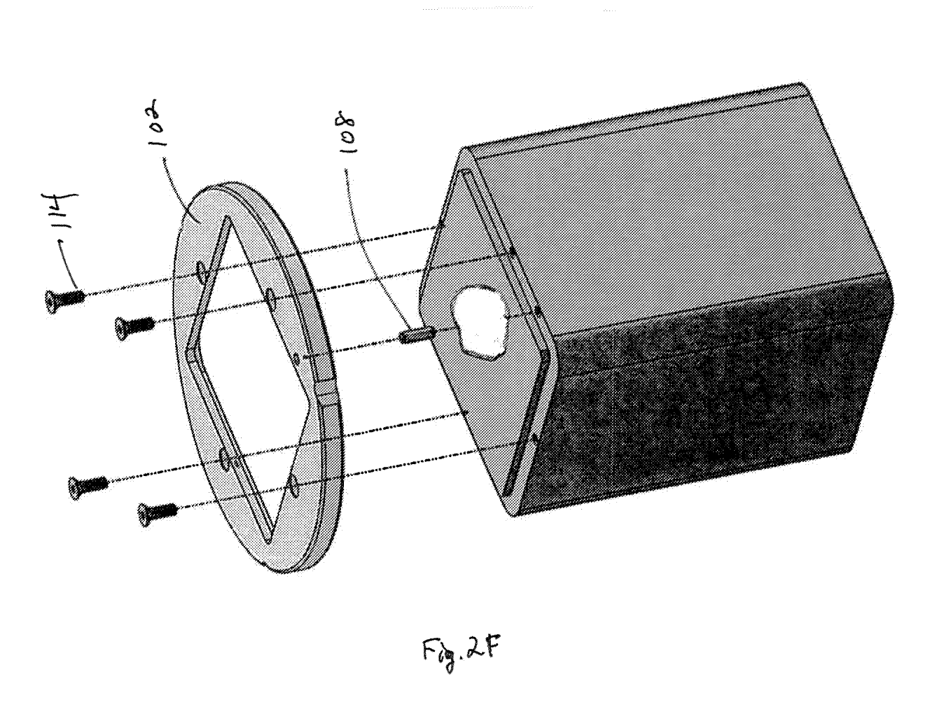

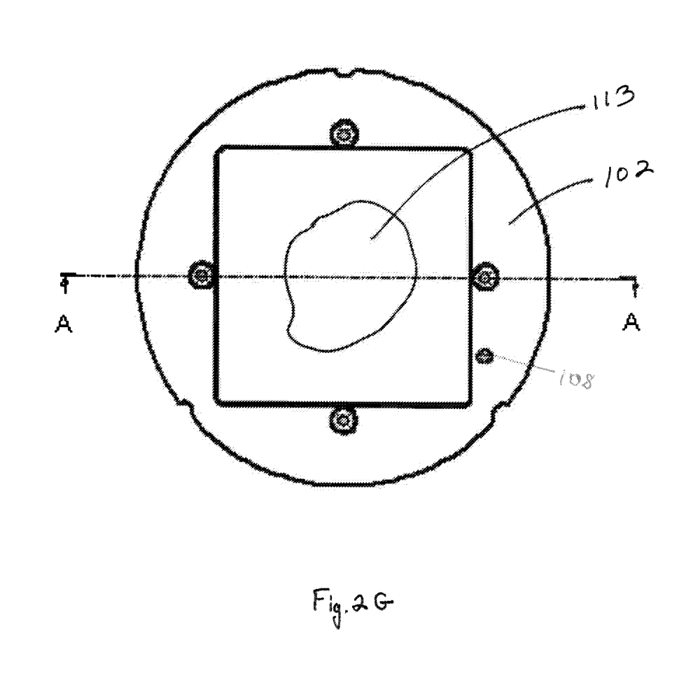

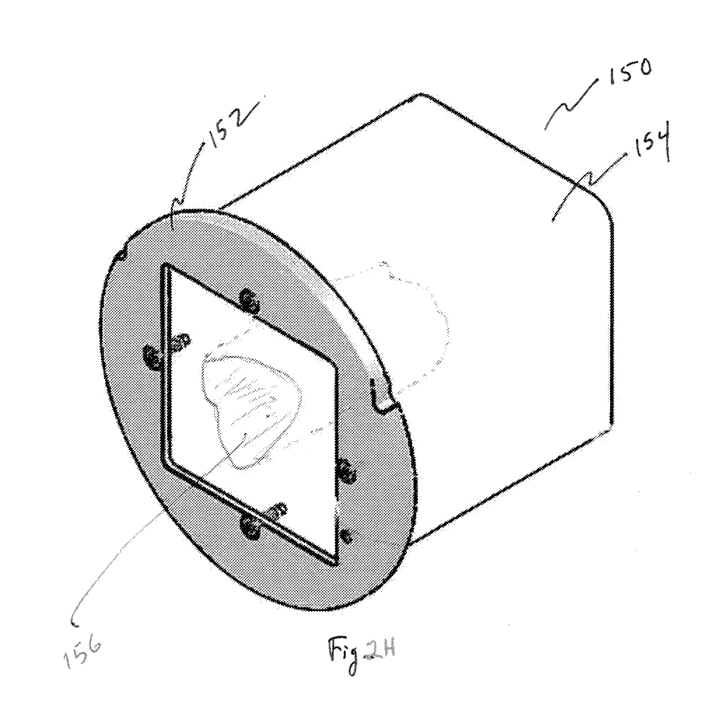

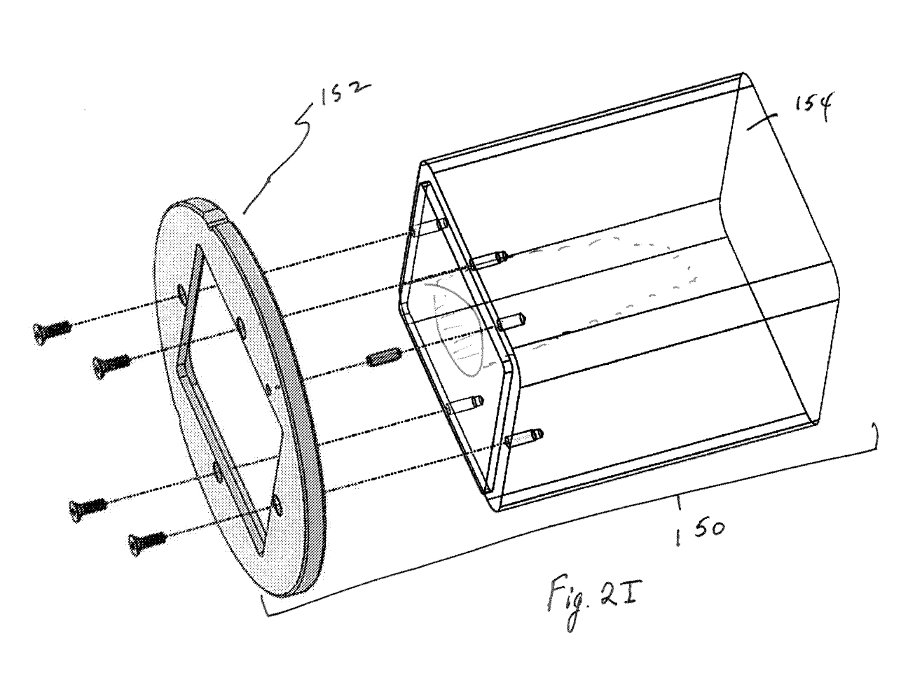

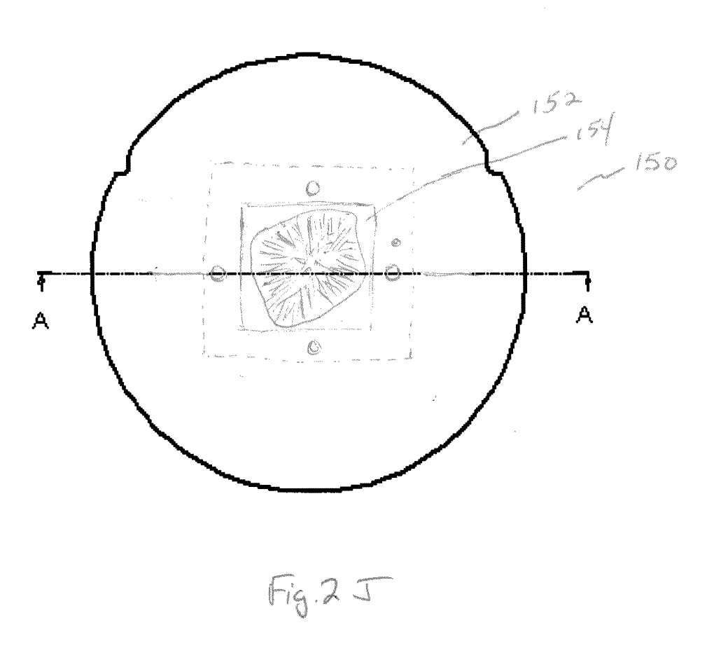

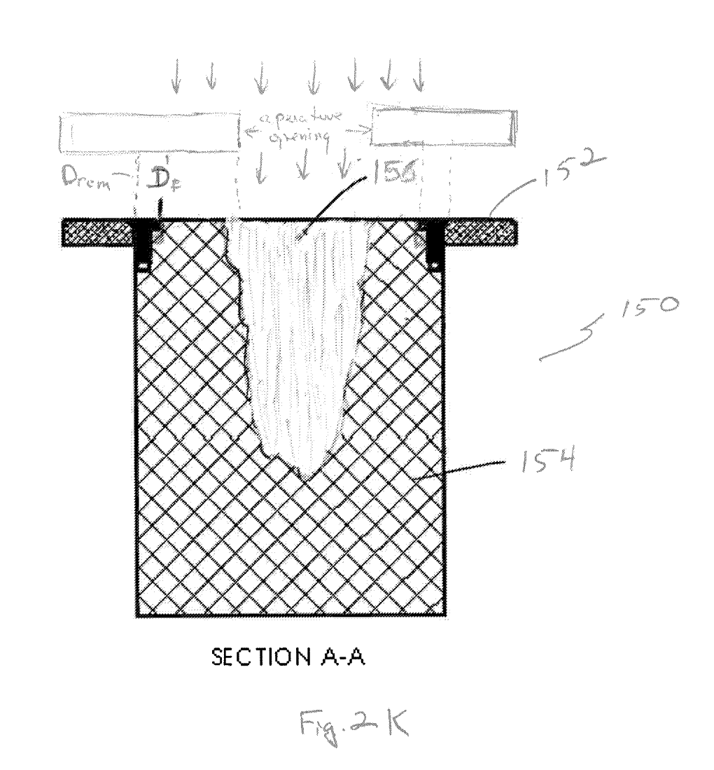

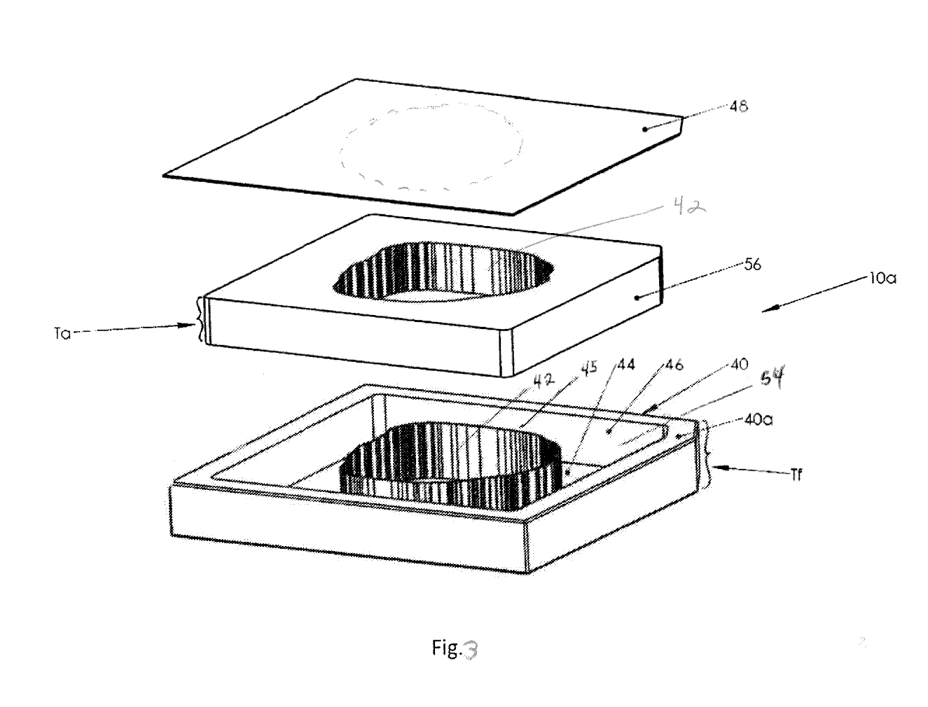

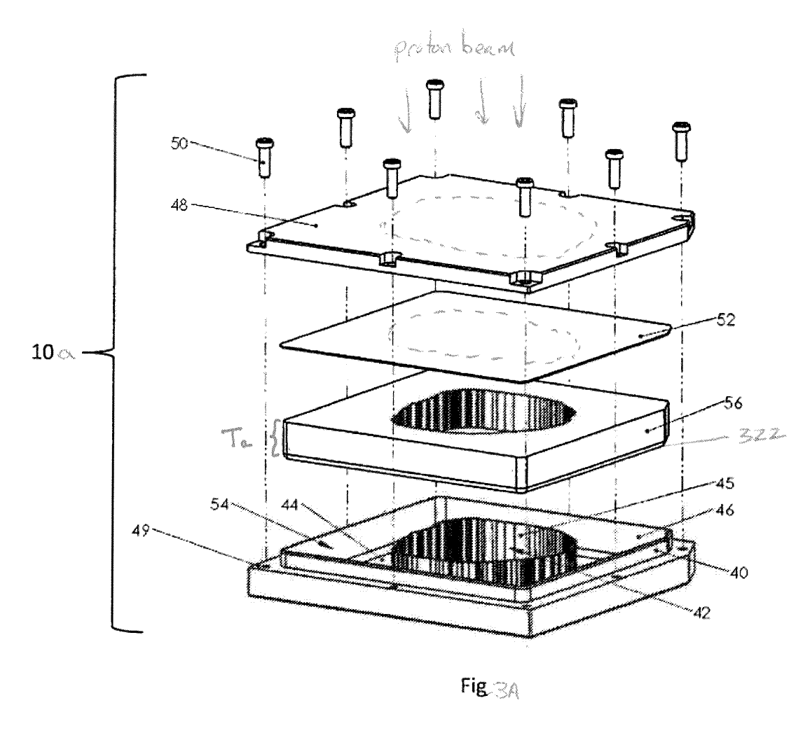

FIGS. 2, 2A, 2B, and 2C illustrate a novel embodiment of Applicants' aperture assembly 10, which is dimensioned and adapted for use with the compensators, including prior art range compensators and those disclosed in FIGS. 2H, 2I, 2J, and 2K, for example, with the Hitachi PBT machine described above, but also adaptable for use with any PBT machine. Aperture assembly 10 is comprised of two elements removably engaged to one another with fasteners (or other suitable means). Aperture assembly 10 in the embodiments illustrated in FIGS. 2 and 2A is comprised of an aperture material 12, in a solid form, such as solid brass, Cerrobend or bronze, which aperture material 12 has an aperture opening 13 therein, which aperture opening 13 is dimensioned and shaped in ways known in the art. A frame 14 is adapted to removably engage solid aperture material 12 through the use of fasteners 36.

As best seen in FIGS. 2 and 2A, it is seen that aperture material 12 is dimensioned to fit fully and snugly within an outer perimeter 15 of frame 14. Moreover, the end result, the combination of aperture material 12 and frame 14 together typically have the same exterior dimensions as the aperture illustrated in the prior art, for example, FIG. 11. However, it is also seen in FIGS. 2 and 2A that although the exterior dimensions L1, L2, W1, W2, and notch N of the frame and the thickness T_{f} of the frame are the same as the prior art separate aperture (see FIG. 11), the use of the frame, which is typically a different material than the aperture material (that is to say, a material different than brass or bronze, for example, aluminum) allows the use of Applicants' combined unit, that is aperture assembly 10 in place of separate aperture as seen in FIG. 1G. Moreover, carefully dimensioning of the frame in accordance with the geometry of the slot of the PBT machine ensures that the aperture material 12 in aperture assembly 10 fully covers the proton beam. That is to say, the outer perimeter and dimensions of aperture material will meet or slightly exceed the inner diameter of the snout. Frame 14 is a standard dimension for the aperture slots of a PBT machine and is reuseable, while the aperture with aperture opening 13 are patient specific. Furthermore, it is apparent from the illustrations that less of the expensive, dense brass (or other aperture material) is used when a frame 14 is provided. The prior art aperture material seen in FIG. 1E or 1G, for example, is cut down in perimeter dimensions to fit within frame 14 and thereby material is saved, such as an expensive brass used typically for the prior art apertures.

Frame 14 is seen to have an outer perimeter 15, which perimeter is a two-dimensional surface comprising a thickness T_{f}, width W1 and W2, length L1 and L2, and notch N or other index means (to index or register the assembly in the slot). This perimeter geometry is substantially identical to the perimeter geometry of the separate aperture seen in FIG. 1G, so as to slot seamlessly into a PBT machine that will receive the separate prior art apertures.

Frame 14 may comprise stepped inner walls 16 extending inward from outer perimeter 15 and including upper rectangular portion 18 and lower rectangular portion 20. Upper rectangular portion 18 defines a first inner perimeter 22 of frame 14. Lower rectangular portion 20 defines a second inner perimeter 24.

Turning back to aperture material 12, aperture material 12 is seen to have stepped outer walls 26, such that aperture material 12 will seat snugly into stepped inner walls 16, substantially flush thereto, and the combined unit defined in aperture assembly 10 having the same external geometry of the separate aperture in FIG. 1G, except being made from a frame and an aperture material separately, fastened together with fasteners 36.

An alignment system may be used to properly position aperture material 12 in frame 14. Here, a round or cylindrical pin 28 is pressed into a corner here, for example, adjacent notch N and a diamond shaped pin 32 is pressed into, typically, the diagonal corner or another corner, for example, when using a rectangular or square frame. This will ensure that the aperture material 12 can only go into the frame ONLY one way and will be snug fitting. Hole 30 is dimensioned to snugly receive cylindrical pin 28 in or near a corner of aperture material 12. A diamond shaped pin 32 with a long width about equal to the diameter of hole 30, and a short width slightly less is seen to snugly engage the hole/slot opening 34, thus providing some wiggle room for properly indexing or aligning the aperture material to the frame (see FIG. 2B). Alternatively, the elongated hole/slot 34 with the same width as the diamond pin, but a length of the slot is longer than the width of the diamond pin, may be used to allow proper alignment when the diamond shaped pin 32 and hole/slot opening 34 are engaged—while allowing some slight movement back and forth until the diamond pin 32 engages the hole/slot 34. With proper engagement, the fasteners 36 will be properly aligned for receipt into the fastener holes 38 as seen in FIG. 2C. Note the fasteners 36 are typically fully recessed (see FIG. 2C).

FIGS. 2D, 2E, 2F, and 2G illustrate another embodiment of an aperture assembly (for a round indexed frame, such as typically IBA or Still River) 100. Aperture assembly 100 is comprised of aperture material 112 engaging frame 102/103. Engagement may be through the use of fasteners 114 and alignment pins 108 may provide (shown with frame 102, but also used with 103) proper alignment of the aperture material 112 to the frame 102/103. Index means 106a and 106b are provided to index frame 102/103 to a slot so that the machine knows that there is an aperture engaged therewith. Index means 106a/106b are typically located on the perimeter 104 of frame 102/103 as known in the art. Aperture material 112, as in the embodiments set forth above, is typically reduced in volume compared to prior art aperture material and thus typically provides a cost savings to the user.

Here is it seen that in comparing a volume of a cylindrical projection of perimeter 104 to the volume of aperture material 112, there is elimination of some of the aperture material so that, compared to prior art, there is less use of the typically more expensive, dense aperture material.

It is also seen with reference to FIGS. 2D and 2E that both ends of the aperture material may comprise one 102/103 frame having separate spaced apart members 102 and 103, the two members dimensioned substantially identically, but fitted to the removed end of aperture material 112. The use of frame 102/103 may allow indexing of the aperture assembly 100 into the slot of a snout of a PBT machine. The spacing of the frame members apart will substantially slot snugly into the slot walls or slot perimeter. For example, if a prior art aperture material is typically a machined cylinder of brass that is between typically about 5 to 13 inches in diameter and about 6 centimeters long, then the spacing of the two members 102 and 103 will be about 6 centimeters apart and their diameter will be between typically about 5 to 11 inches. For example, the small IBA systems PBT machine may have a slot for receipt of one of the prior art brass cylinders that are 6 centimeters long and about 8 inches in diameter. Using Applicants' novel aperture assembly 100, the two members 102 and 103 would be spaced about 6 centimeters apart and their diameter would be about 8 inches. Moreover, their index means (typically on one or both members) 106A/106B will be aligned. Further, the aperture material may be rectangular or squared shaped, or may be cylindrical just reduced in size from the diameter of the frame 102/103. In any case, the external dimensions and perimeter of the aperture material will typically just exceed the id of the snout.

In the embodiments set forth in FIGS. 2D through 2G, it may be seen, however, that as with other embodiments illustrated herein, the outer perimeters of the aperture material in these embodiments will be sufficient to fully cover the proton beam projected thereupon. That is to say, there will typically be no leakage of proton beam radiation outside of the outer perimeter of any of the aperture material portions. Substantially all of the beam outside the aperture material will typically be blocked and substantially all of the beam passing through the aperture material will typically be subject of range modulation.

The outer perimeter of the frame is dimensioned for receipt into the slot of the PBT machine. Thus, its shape and dimensions are determined by the PBT machine for which it is intended to be used. However, the inner dimensions and the inner openings of the frame may be round, square or any other suitable shape. However, for the IBA and Still River Systems machines, aperture material 112 is preferably cylindrical with an outer diameter that is just slightly greater than the inner diameter of the snout (which defines the borders of the proton beam), but is typically less than the outer diameter of the frame.

As set forth above with the discussion of the prior art PBT snouts, it is apparent that some have more than one slot for the aperture. In any of Applicants' embodiments set forth herein where, for example, a single aperture assembly may be sufficient to absorb or stop the protons, the remaining one or two slots of the PBT machines may receive a frame without any aperture material therein. This is so that the machine, looking for two or three (i.e., a full set) slots will still operate. If Applicants provide a higher density aperture material capable, in one aperture assembly, of performing the necessary proton beam absorption, where the prior art would require three, in three slots of the snouts, Applicants provide two index or blank frames (with no aperture material therein) for inserting into the remaining slots.

FIGS. 2H, 2I, 2J, and 2K show a range compensator assembly 150 similar to the aperture assembly may also be provided comprising a frame 152 and a range compensator material 154 having a milled opening 156. As in the embodiments set forth above, alignment pin fasteners, index means, and the like will be provided. Furthermore, the range compensator material 154 will typically provide entire beam coverage for the beam projecting through the upstream aperture opening (see FIG. 2K).

With respect to Applicants' range compensator assembly 150, it is seen that the diameter across the range compensator material 154 need only be outside the aperture opening (and a margin for beam divergence) as seen, for example in FIG. 2K. D_{f} is the inner diameter or the shortest diameter across the inner perimeter of the frame. D_{rcm} is the smallest diameter across the range compensator material. It is seen that Applicant typically sizes the range compensator material based on the aperture opening, such that the range compensator material typically is exposed to all of the proton beam, yet D_{rcm} is smaller than the outer dimensions of the frame and just large enough to receive the fasteners adjacent the inner perimeter of the frame opening (see FIG. 2J).

Thus it is seen that the range compensator material typically has to be outside the profile of the aperture material opening plus a margin or divergence of the proton beam and large enough to receive fasteners. Furthermore, the range compensator material 154 is stepped back from the outer diameter of the frame to save on material costs in manufacturing. The inner diameters or shapes of the frame 152 for engaging the range compensator material is chosen from a set of varying inner diameters or shapes, that is a pre-manufactured set of stock inner diameters or shapes, so as to use the frame that will be outside the proton beam, but sufficient to engage the fasteners to the range compensator.

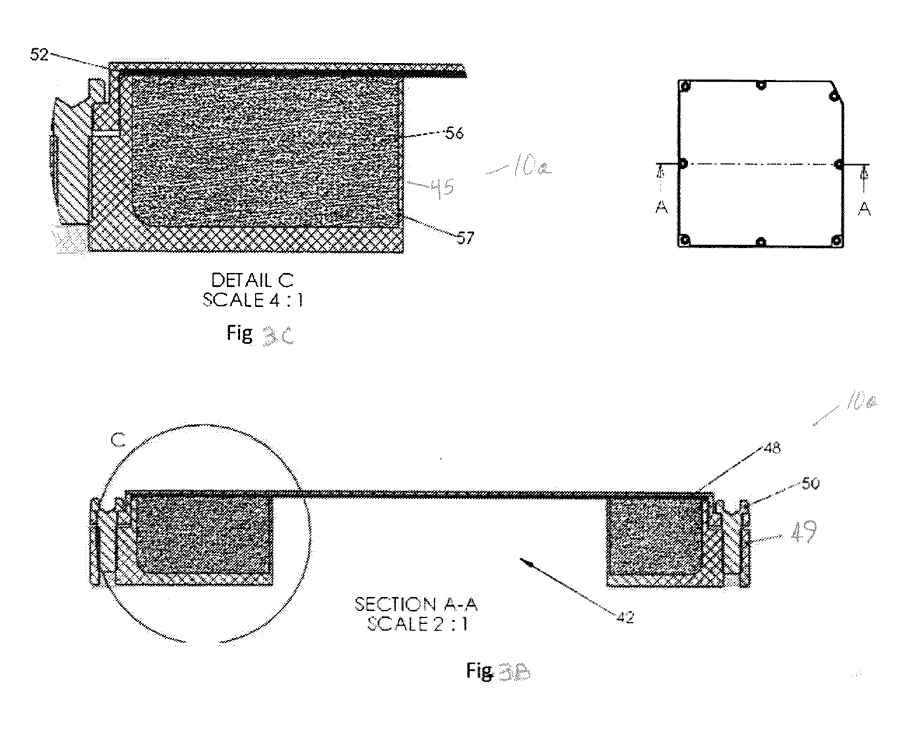

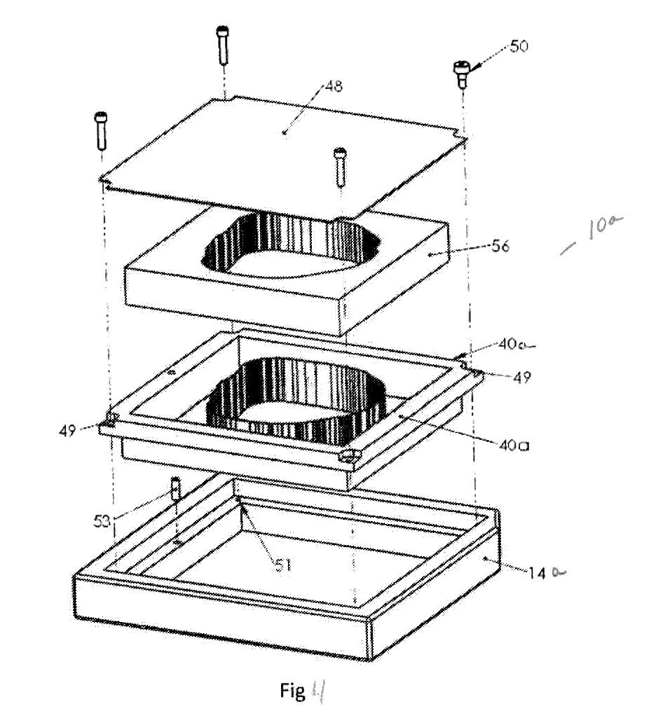

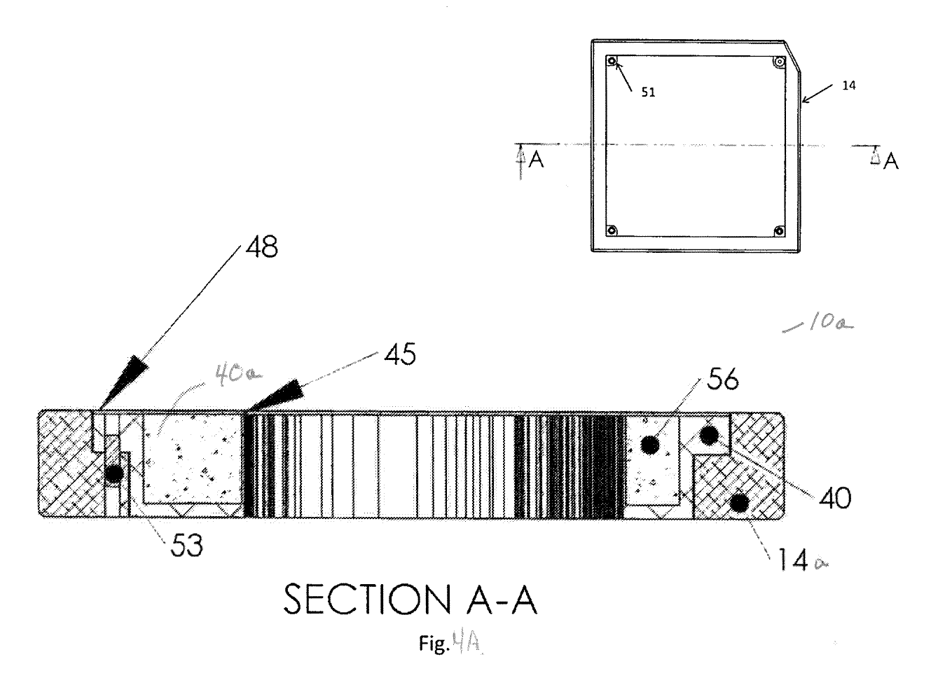

FIGS. 3, 3A, 3B, and 3C illustrate another embodiment of Applicants' aperture assembly 10a, with a frame thickness T_{f} and exterior dimensions designed to rest substantially flush against a prior art range compensator to be used therewith for insertion into slot the snout of a PBT machine. This embodiment has a frame integral with a shell defining a cavity, here designated frame 40. That is to say, aperture assembly 10a has exterior dimensions and shaped substantially identical to the embodiment as set forth in FIGS. 2 and 2A, and to the prior art aperture seen in FIG. 1G. Thickness T_{f} of frame 40 is standard to the snout. Thickness Tₐ of aperture material 56 may be typically less than T_{f}. While a rectangular frame is illustrated, a round shape is also anticipated.

In an alternate embodiment (FIG. 3A), the dash lines on top plate 48 and gasket 52 show that these elements may be cut out to match the patient specific aperture opening 42. FIG. 3A also illustrates the use of a neutron barrier 322 on the underside of (that is, downstream of the proton beam), which neutron barrier 322 will cover the entire underside of the aperture material 56. It is made of material suitable to absorb neutrons that may be generated by the nature of the aperture material used by Applicants as set forth herein and specifically with the interaction of the aperture material with the proton beam.

It is seen in FIGS. 3, 3A, 3B, and 3C that Applicants provide a frame 40. which frame includes aperture inner walls 45 defining an aperture opening 42 dimensioned in ways known in the prior art and patient specific. Gasket 52 may be used and may be in the nature of an elastomeric or pliable sheet material which may substantially cover the full surface of the underside of top plate 48, so as to both substantially seal around the top perimeter of inner side walls 46, but also substantially seal along the upper perimeter of aperture inner walls 45. A modified gasket may also be provided with a cutout identical to aperture opening 42. One is ensured of engagement of the pliable gasket 52 to the underside of the top and that the gasket material will typically follow the boundary of the cutout to effectively seal against the top walls of aperture inner walls 45. Frame 40 may include walls defining floor 44, inner side walls 46, and a separate top 48 plate. Top plate 48 is separate from frame 40, but is removably fastened thereto using fasteners 50. Fasteners 50 are threaded and engaged with threaded bores 49 of frame 40. Gasket 52 may be provided for a snug leak-proof seal between the outer perimeter of top 48 and the upper perimeter of inner side walls 46 and aperture inner walls 45.

In FIG. 3, aperture inner walls 45 are seen to define aperture opening 42. A cavity 54 is defined by the inner side walls 46, floor 44, and aperture inner walls 45, which cavity is capable of being filled with a powder, mix, liquid, slurry or even a solid material, and which cavity 54 may be snugly fitted with a leak-tight seal through the use of top 48 (typically with the gasket) and fasteners 50.

In an alternate embodiment (not shown), gasket 52 may be bonded to the underside of top 48 before the top is attached to the frame 40. Furthermore, an alternate to the “full coverage” top 48 is one in which aperture opening 42 is replicated in the top 48 (see dashed lines in FIGS. 3 and 3A), positioned to register with aperture opening 42 of the cavity. Top 48 may be cut out to the profile of aperture material or be uncut. If solid, range compensator will be adjusted for the additional thickness.

Solid, liquid or a mix of shell filling aperture material 56 is typically placed in or otherwise set into cavity 54 to partially or completely fill the same. Gasket 52 may then be put into place and fasteners 50 are engaged to unthreaded or threaded bores 49 to substantially seal aperture material 56 within cavity 54 (see FIGS. 3B and 3C). Shell filling aperture material 56 may be sealed in cavity 54 by melting a material, such as wax or resin, or using a glue and pouring it into the cavity, over, under or mixed within the aperture material 56. This may help avoid leakage. Such sealant material may allow for the deletion of top 48 and gasket 52.

Thus, it is seen how a non-solid material, such as a powder, shot, fluid or a shot and powder or any other suitable mix, may be placed in cavity 54 and such aperture material will typically function in the same way as the solid, dense aperture material of the prior art or of the previous embodiment, but may easily be extracted or removed from the cavity for reuse. Aperture material 12 of the previous embodiments, typically being solid and already having a custom, patient-specific aperture opening therein, may be re-melted for reuse. On the other hand, one may use a non-solid (fluid) or similar material in place of the solid aperture material, for example, one or more of the following non-solid materials (powder or slurry): ecomass, cerrobend, and tungsten. This allows easy reuse. An appropriate thickness of material will typically sufficiently shield off the proton beam just as the prior art brass does.

Typically, inner surface 57 of aperture inner walls 45 will define the patient specific aperture opening—inner surface being flush with aperture material 56. This may leave inner walls 45 within the aperture opening. The inner walls may be made thin enough, to about a millimeter or less so that this will typically not be a problem. However, this wall thickness within the aperture opening may be offset by the range compensator material downstream directly in the proton beam being decreased by the wall height or an equivalent decrease so as to keep the modulation the same as if there were no inner walls 45 in the aperture opening. This assumes the frame 40 is made from the same material as the range compensator.

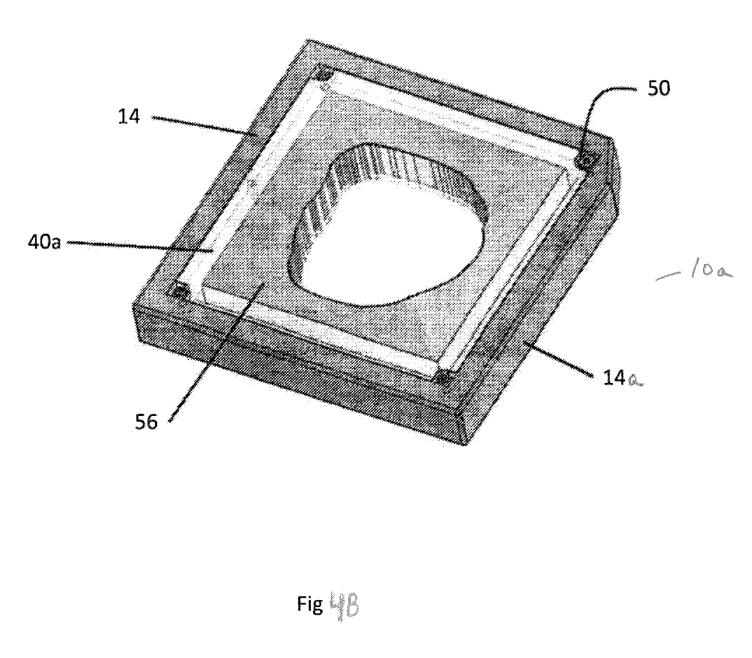

FIGS. 4, 4A, and 4B illustrate another alternate embodiment of a cavity 40a having stepped back side walls, so as to seat with reuseable frame 14a and where fasteners 50 are designed to engage top 48 and, typically, gasket 52. However, cavity 40a may provide threaded section 49 extending fully through top to bottom and will align with threaded sections 51 of frame 14a. Dowel pin 53 may be used to ensure that cavity 40a goes into frame 14a in proper alignment. Moreover, dimensions of frame 14a along with the added thickness of stepped side walls 46a will be such that aperture material 56 will extend greater than the inner diameter of the snout of the beam accelerator machine. That is to say, as regards to the proton beam of the beam accelerator machine that is cast or projected downward through the snout toward the cancer patient, all of the embodiments set forth in this application provide full coverage of the aperture material to the proton beam, especially at the outer perimeter, without any “leakage.” As seen in FIG. 4A, top 48 may be sonically welded to cavity 40a. Fasteners 50 (FIG. 4B) may be used to secure top 48 to cavity 40a (see FIGS. 4 and 4A).

Before turning to the integrated embodiments set forth below, Applicants note the following about the preparation of aperture materials, either solid at room temperature or non-solid, such as a slurry or mix at room temperature. Regarding aperture materials that are solid at room temperature, they typically are used with the separate frame rather than the integral frame shell or separate frame/shell embodiments set forth above. Regarding the aperture material that at room temperature will be non-solid, they are typically used in one of the cavity or shell embodiments set forth above.

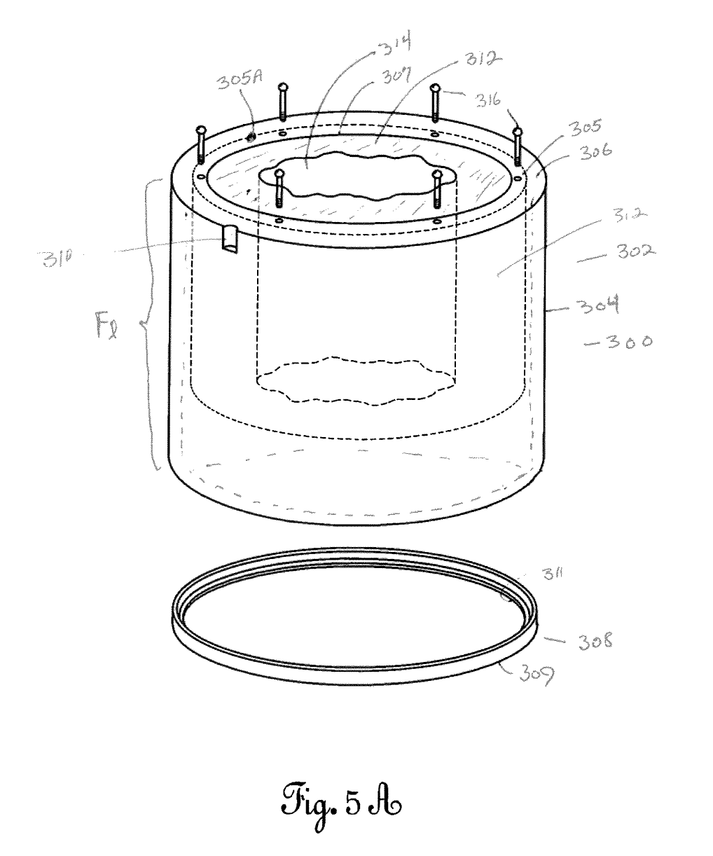

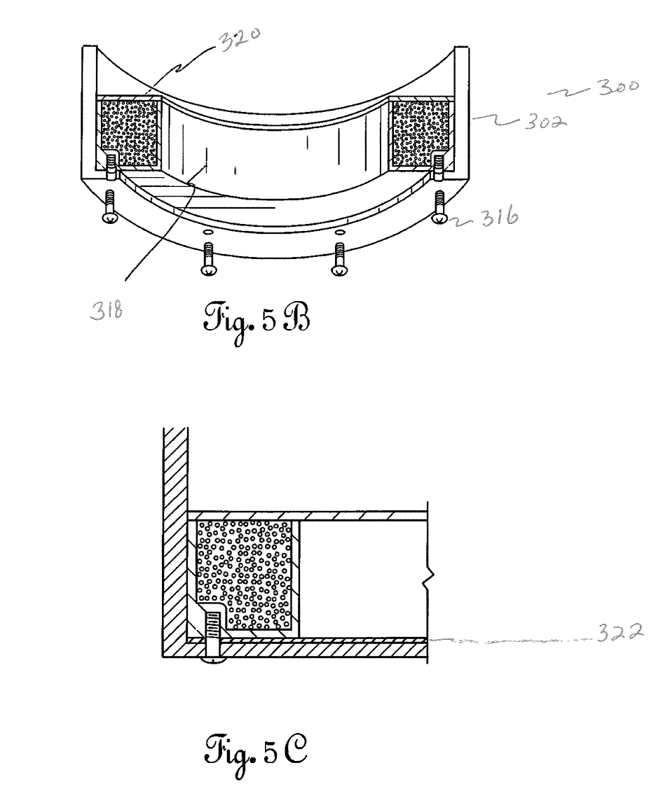

FIG. 5A is another embodiment of Applicants' aperture assembly 300 comprising again as in the earlier embodiments, a separate frame 302 for removably engaging a solid aperture material 312 through the use of fasteners 316 for engaging the frame to the aperture material. In the embodiment illustrated in FIG. 5A, frame 302 is a substantially hollow cylindrical member having a frame length F1 and overall radius that is standard to a slot of present machines and having index notches or means 310 thereon. Frame 302 comprises a cylindrical member which may be aluminum, plastic or any other suitable material, which cylindrical member includes cylindrical sidewalls 304. A top wall 306 projects inward to an inner perimeter 307. which may be circular, rectangular or other suitable shape. A removable, snug-fitting bottom wall 308 may optionally be provided having a bottom surface 309 and an inner perimeter 311. As can be seen, bottom wall 308 has an upstanding annular lip that will allow it to slip inside and fit snugly to the cylindrical bottom edges of sidewalls 304.

On the top wall 306 are a multiplicity of fastener holes 305. One hole 305A may be for receiving an indexing pin to index aperture material 312 with index notches 310 indexing aperture material to the frame will proper register of the frame to the slot in which it is received. Aperture material 312 is typically solid and may be machined in ways known in the art and will have a patient specific aperture opening 314 therein. However, the stock material, such as a brass cylinder or cube from which aperture material 312 will be milled, is typically smaller both in diameter and in length than frame 302. As in the earlier embodiments compared to the prior art, a smaller stock material may be machined and there will be less waste. Further, the length of the cylindrical, rectangular or other aperture material 312 shape may be smaller than or less than the length of stock prior art cylinders. These smaller cylinders may be the equivalent of about 6 centimeters of brass, for example, for the IBA machine, or for the Still River systems approximately 6 centimeters.

A proton beam has a well defined known range of penetration, dependent on its energy and the nature of the material that it strikes. Applicants may provide aperture material having a stock length smaller than that used for brass where the material used for the aperture material is better at absorbing proton beams of a given energy than the brass. Indeed, the length of such material can be provided to an equivalent length of stock brass necessary to stop the proton beam. For example, if a thickness of 4 centimeters of an aperture material “X” has the stopping or beam blocking properties of 6 centimeters of brass, then the length of the aperture cylinder, rectangular or other material in the proton beam may be about 4 centimeters.

FIGS. 5B and 5C illustrate an embodiment of the frame 302 seen in FIG. 5A for use with engaging a cavity 318 snugly therein. Cavity 318 may be filled with a poured aperture material which may cool or chemically set or may be filled with a fluid (non-solid) aperture material or any other aperture material disclosed in these specifications. A cap or lid 320 may be provided and sonically welded to the cavity 318, especially where a non-solid at room temperature is used in cavity 318. Fasteners and indexing will also be provided as set forth hereinabove.

FIG. 5C illustrates the use of a neutron barrier 322 for use with any of the aperture embodiments set forth herein. The neutron barrier may be a material, such as boron in-fused ABS or 1-5% borated polyethylene for absorption of neutrons. The neutron barrier is provided anywhere downstream of the aperture material and is shaped with an aperture opening which is patient specific and will completely cover the downstream profile of the outer dimensions of the aperture material. The function of the neutron barrier is to absorb any neutrons kicked out by the collision of proton beams with the high density material, for example, tungsten, that may be used as aperture material in any of Applicants' embodiments herein.

As with earlier embodiments of the aperture material/frame combinations, FIGS. 5B and 5C, which illustrate a cavity for receipt of aperture material thereinto, the cavity outer diameter would typically be greater than the inner diameter of the snout. Moreover, the cavity may take any shape and the interior dimensions of the frame may take any shape. The outer dimensions of the frame are typically provided for receipt into the snout, but the inner shape of the frame and the inner shape of the cavity may be any shape that will achieve full coverage of the proton beam, yet have the proper patient specific aperture opening and that is properly indexed to the frame so it is positioned properly in the snout. These shapes may be round, rectangular, cylindrical, etc.

Yet only a small centrally located portion of that stock aperture material would be removed. It is seen with Applicants' separate frame and aperture material that smaller sized stock work pieces (but still sufficient to cover the id of the PBT snout) may be used from which to fashion small apertures. Thus, the inner dimensions defining the inner opening of the frame and the location of the fasteners around the inner perimeter may come in a variety of standard sizes, for example, small stock aperture materials (round or cylindrical) and medium or larger for larger aperture openings requiring larger stock pieces.

Applicants will discuss in more detail the nature of a material for use in the aperture assemblies or integrated assemblies set forth herein that have a cavity for receipt of an aperture material there into. First, a low melting point suitable aperture material may be used. It may be heated, poured into the cavity, and then allowed to cool. Further, a chemically setting mix may be prepared using a mixture of a resin, epoxy or other chemically settable material along with a suitably dense material, such as a powder of tungsten or the like. After mixing the ingredients, they may be poured into the cavity and allowed to set. The temperature or chemically setting materials may be used without a seal or lid, or may be used with a seal or lid.

Wood's metal, known by the commercial name of Cerrobend®, has an approximate melting point of about 158° F. (which may vary with allow content) It can be made up of about 50% bismuth, 26.7% lead, 13.3% tin, and about 10% cadmium by weight. Cerrobend may be melted and poured into any cavities illustrated or described herein for receipt of aperture material therein.

Cerrobend, however, may be dangerous to mill, as it contains lead. It may, however, be molded. For example, typically a machineable wax mold may be made to create the patient specific aperture opening and Cerrobend may be poured in that mold and allowed to cool. When cooled, the mold could be broken (and the wax reused) and the solid Cerrobend may be used either in a cavity or in any other embodiment calling for aperture material herein, including direct engagement with a frame or frames for slotting into an aperture slot of a PBT machine. Indeed, machineable wax may be available with a softening or melting point significantly higher than that of Cerrobend.

A milled negative mold of machineable wax in the proper dimension may be provided for any of the aperture material needed herein. The mold may be used then for pouring any of the non-solid materials (at room temperature) or the chemical settable materials there into. After removal of the aperture material from the molds, it may be machined, if necessary, or sanded or otherwise, if necessary. Typically, index marks will be molded on the aperture material to allow it to slot into the cavity if a cavity is used or to engage a frame if a frame is used. If a frame is not being used and the molded material is being slotted directly into the aperture slots, then the negative molding would contain a member for proper engagement and indexing of the aperture material with the slot.

While Cerrobend is discussed for molding herein, any high density material (capable of absorbing, perturbing or stopping proton beams) with a low melting point or any high density material (capable of absorbing, perturbing or stopping proton beams) as a flowable non-solid alone or that may be mixed with a resin, epoxy or the like for chemical setting. A gas or plasma suitable for stopping protons may also be used.

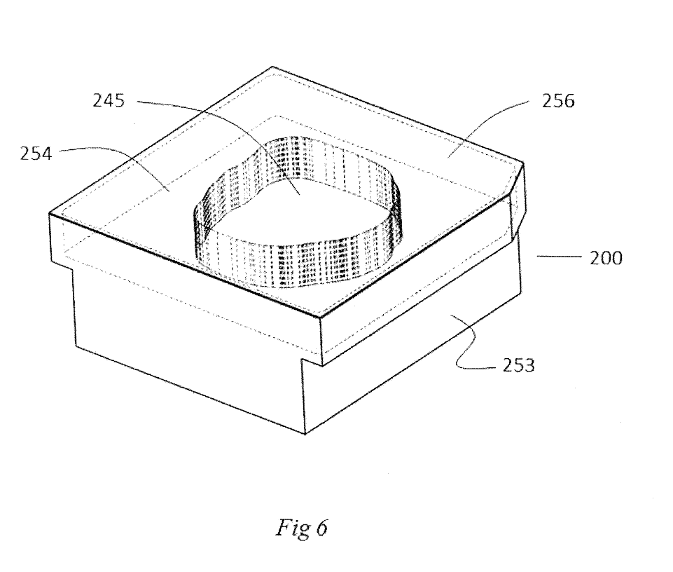

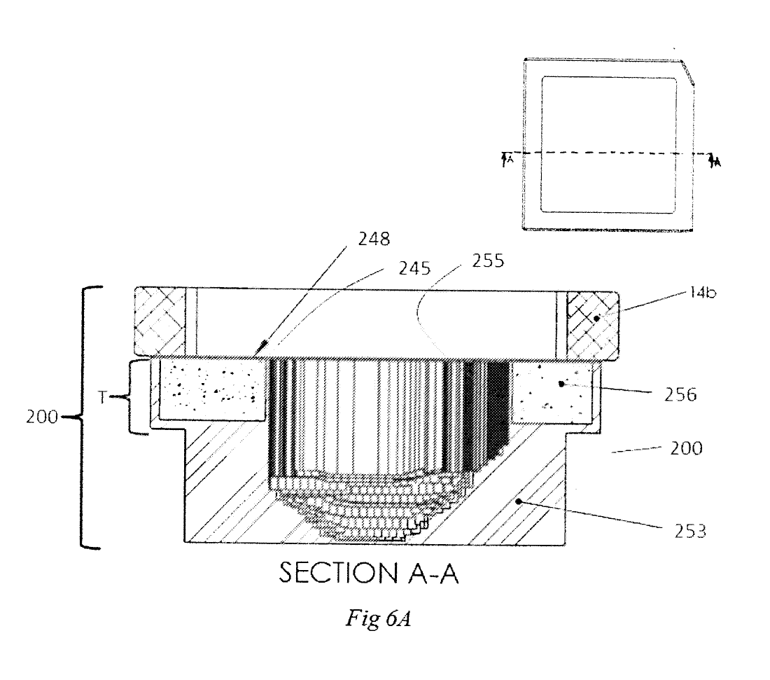

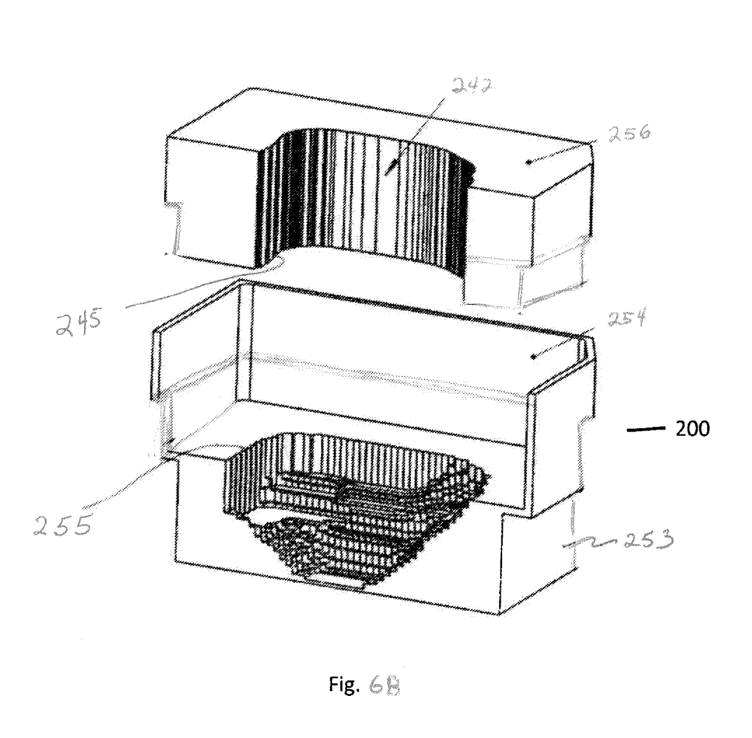

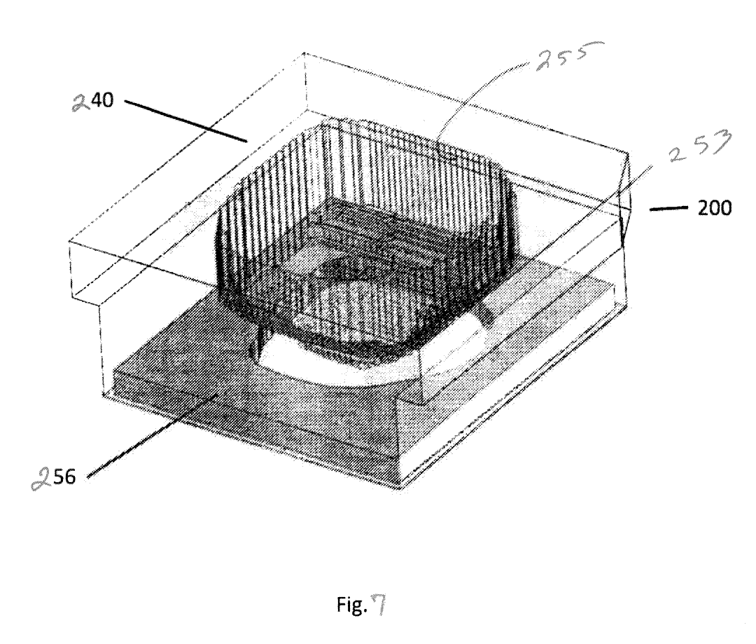

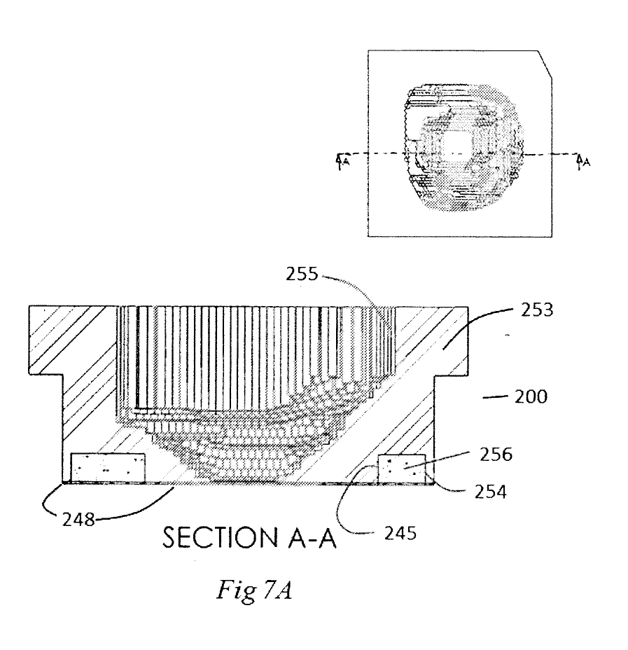

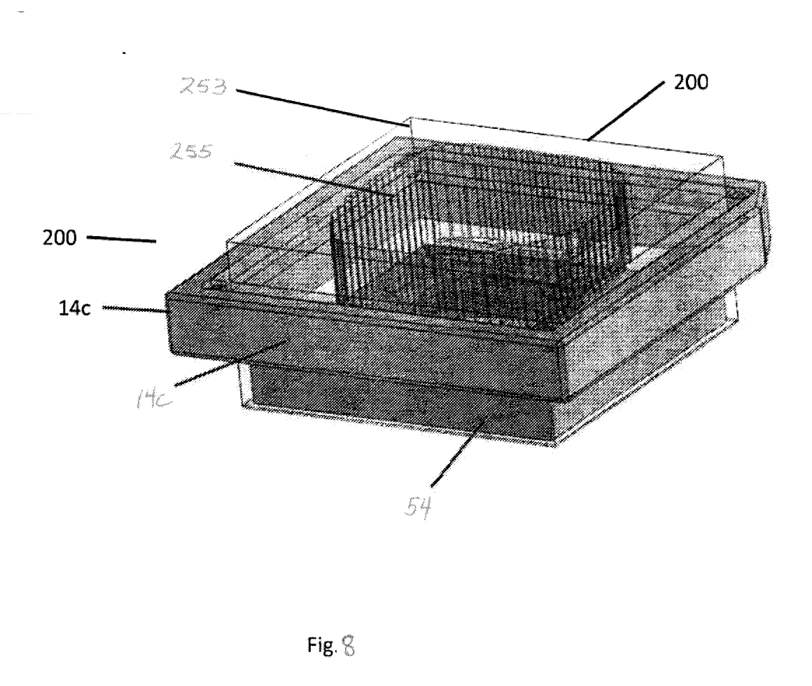

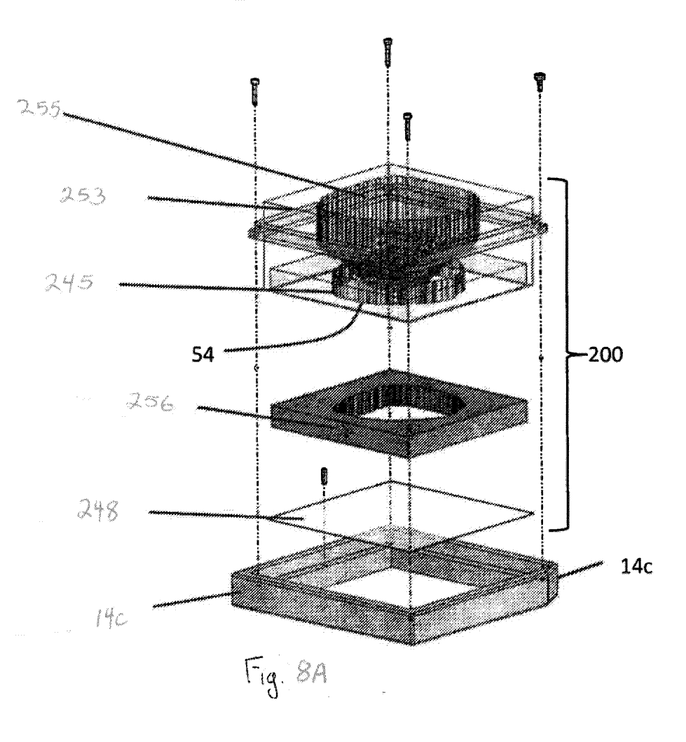

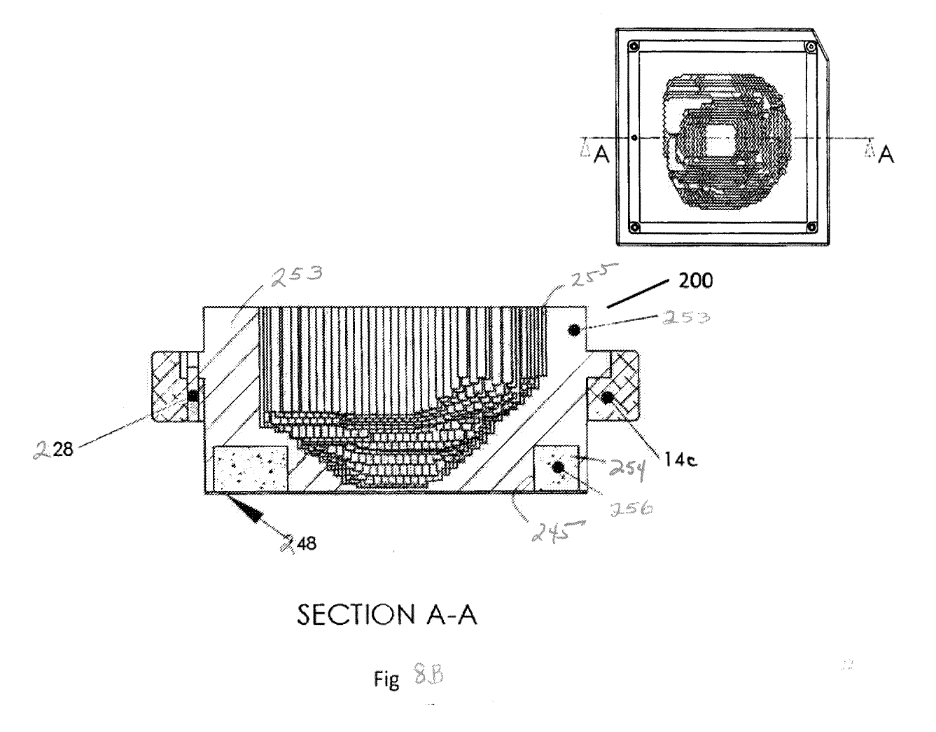

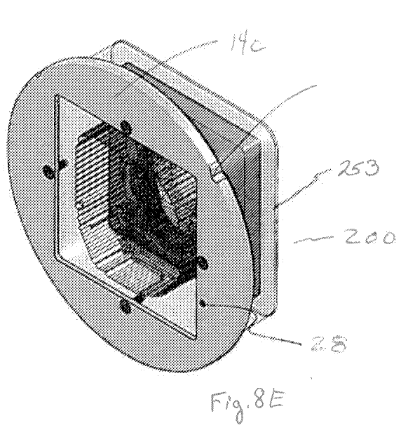

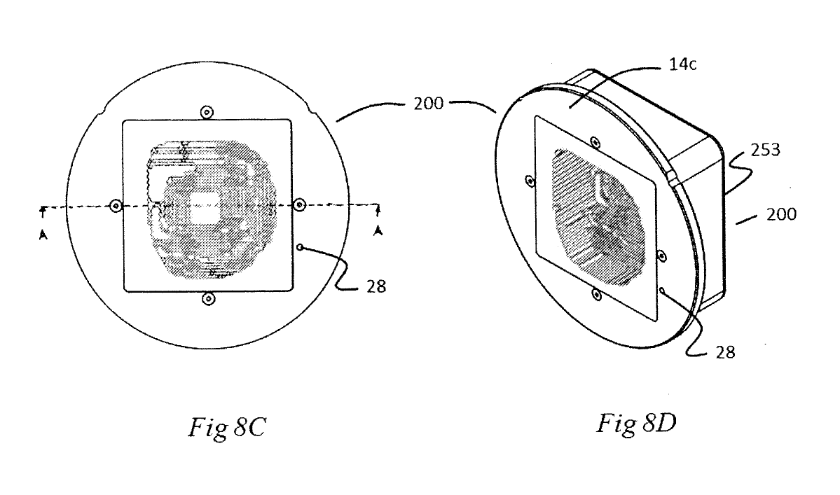

The next embodiments, FIGS. 6, 6A, 6B, 7, 7A, 8, 8A, 8B, 8C, 8D, and 8E illustrate an integrated proton beam modification device in which a single piece provides the aperture material function and a range compensator material function. An integrated assembly 200 may be considered an assembly comprising a single piece that contains elements for achieving the blocking function of the aperture and elements for performing the modulation function of the compensator. It may or may not include a frame. Cavity 254 is shaped at the upper or lower portion thereof. Inner walls 245 (defining the aperture opening) may be simply compensator material 253 left standing following the milling or excavation of cavity 254. The inner face of inner walls 245 are typically flush and projected downward or upward, may represent the outline or perimeter 255 of the milled out cavity in the range compensator material. The various embodiments illustrated may be referred to as an integrated assembly 200, to designate a single assembly performing both shielding (aperture) and range compensating functions. Integrated assembly 200 may be used with or without a spacer frame 14b and with or without engagement frame 14c and may be constructed so that compensation is substantially downstream of aperture shielding (normal) (see FIG. 6) or upstream of the aperture shielding (see FIGS. 7 and 8).

FIGS. 6 and 6A illustrate an embodiment, typically a one-piece compensator material 253 milled or otherwise dimensioned to accept aperture material 256 and provided optionally with top 248 fastened thereon. The embodiment set forth in FIGS. 6 and 6A has a thickness of T. Having a thickness of T, it is seen that it may not slot or align in with the head of the PBT machine. However, providing a generally rectangular, square or round spacer frame 14b (see FIG. 6A) acting essentially as a spacer (mimicking the perimeter of a separate prior art aperture), will provide for proper snug fit and alignment of integrated assembly 200. The embodiment of FIG. 6B is similar to FIGS. 6 and 6A, except cavity sidewalls 254 and aperture material 256 are dimensioned so that no spacer frame 14b is needed, and the integral assembly may be used with existing PBT machines.

FIGS. 7 and 7A are similar to the embodiment of FIGS. 6 and 6A; that is to say, it is a one-piece unit integrated assembly 200 where the modulation structure/function (compensator material) 253 and the shielding structure/function (aperture material 256) are together in a single unit. However, the high density material (aperture material 256) is on the bottom (toward the patient) of the integrated assembly 200. High density aperture material 256 is placed in a machined out cavity 254, which cavity bears the proper profile of the aperture. Top 248 is used (however, now being on the “bottom” and not on top). In an embodiment not shown, a solid machined aperture material, with a profile cutout may be physically attached to the bottom of the range compensator, with the range compensator adjusted for dimensions so it will engage the standard snout. In this embodiment, the range compensator compensates first and then the profile is defined by the aperture material 56 after the proton beam has been modulated.

FIG. 8 illustrates that engagement frame 14c engages integrated assembly 200 such that, in relation to the PBT head, compensating material extends towards the head (away from the patient) and may place the aperture (shielding) material downstream of engagement frame 14c. Frame 14c is standardized dimensionally to engage PBT head and is reuseable.

FIG. 8, 8A, 8B, 8C, 8D, and 8E illustrate an embodiment whereby a range compensator material contains a cavity 254 in the bottom of the integrated assembly 200 for receiving, typically non-solid, high density shielding material. Furthermore, there is a notch or shoulder at least partway up the outer side walls of the milled range compensator material whereby reuseable engagement frame 14c of standard dimension for a range compensator slot may be attached. For example, fasteners may be used to attach the engagement frame 14c to the lip, notch or shoulder extending outward from the side walls of the compensator material. Moreover, engagement frame 14c is a standardized dimension for receipt into the snout of existing PBT machines. That is to say, the engagement frame 14c is dimensioned for the range compensator slot in the snout on the exterior perimeter thereof. The interior perimeter of the engagement frame is dimensioned to engage the integrated assembly 200. Moreover, the range compensator material may have high density fill (shielding) material on the underside or bottom thereof which is sealed with an acrylic seal or top 248 as seen in FIG. 8A. In this embodiment, the shielding of the proton beam or other beam is downstream of the initial modulation to shape the beam. Cylindrical pin 28 may be used as in earlier embodiments as well as top 248 (especially for non-solid aperture material).

FIGS. 8C, 8D, and 8E illustrate an embodiment of Applicants' integral assembly 200 in which compensator material 253 is, as in previous embodiments, made smaller than the exterior dimensions of the frame or slot engaging walls of the existing PBT machine. However, in these embodiments illustrated, it is seen that the outer perimeter of the frame is round and indexed for a seat into standard existing PBT machines, such as IBA or Still River systems. Moreover, the milled out compensator material 253 also has been milled to provide a properly aligned cavity for receipt of the aperture material therein. With the compensator material milled for both cavities for receiving the aperture material and milled to the proper range compensator profile, there is no need for indexing the two materials, one with the other as it is done in the milling process. Moreover, it is seen that a round frame may include the milled rectangular or other shape (including cylindrical) compensator material for joining with a separate engagement frame 14c, which frame in turn indexes to the slot (with or without a spacer frame) of an existing PBT machine.

FIG. 8D illustrates another use of Applicants' neutron barrier 322, used downstream of aperture material 256, which is placed in cavity 254. FIG. 8D also shows how a spacer frame (one or more, depending on the number of aperture slots) is used when the integrated unit is placed in the range compensator slot Sc of the snout.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. For use with a PBT machine, the PBT machine having a gantry and a snout and a proton beam emitter for emitting a proton beam, the gantry for engaging the snout, the snout having an inner diameter and one or more slots, the one or more slots having slot walls and having indexing means thereon, the slots having a perimeter, a system for modifying the proton beam, the system comprising:
an integrated assembly adapted to have an aperture material portion and a range compensator material portion, the two materials of different compositions.

2. The system of claim 1, wherein the integrated assembly includes exterior walls adapted to engage the slot walls.

3. The system of claim 1, further including a frame, the frame adapted to engage the slot walls and the integrated assembly.

4. The system of claim 1, wherein the portion of the integrated assembly includes a cavity having outer walls greater than the snout inner diameter and inner walls defining the aperture opening.

5. The system of claim 4, wherein the cavity is substantially upstream of a modulation profile of the range compensator material.

6. The system of claim 4, wherein the cavity is substantially downstream of a modulation profile of the range compensator material.

7. The system of claim 4, wherein the integrated assembly includes exterior walls adapted to engage the slot walls.

8. The system of claim 4, further including a frame, the frame adapted to engage the slot walls and the integrated assembly.
